(19) United States
(12) Patent Application Publication
(10) Pub. No.: US 2026/0109126 A1
(43) Pub. Date: Apr. 23, 2026

(54) WATER ACTIVATED TAPE (WAT) CARTON SEALING APPARATUS WITH TOP AND BOTTOM CARTON FEEDING AND METHOD OF CARTON SEALING

(71) Applicant: Intertape Polymer Corp., Sarasota, FL (US)

(72) Inventors: Mark Patrick McCrate, New Haven, CT (US); Douglas G. Walker, Middlebury, CT (US)

(73) Assignee: Intertape Polymer Corp., Sarasota, FL (US)

(21) Appl. No.: 19/359,337

(22) Filed: Oct. 15, 2025

Related U.S. Application Data
(60) Provisional application No. 63/709,069, filed on Oct. 18, 2024.

(51) Int. Cl. B31B 50/72; B31B 50/74

(52) U.S. Cl. CPC B31B 50/72; B31B 50/741

(57) ABSTRACT

A WAT carton sealing apparatus utilizes a top carton sealing assembly and a bottom carton sealing assembly to improve the speed at which cartons are sealed. The top carton sealing assembly moves vertically with respect to the bottom carton sealing assembly to seal cartons of different heights. The top carton sealing assembly may utilize top and bottom carton feeder assemblies, top and bottom tape applicator assemblies, and top and bottom WAT tape head assemblies. The feeder assemblies at least partially feed a carton through the carton sealing apparatus by engaging the top and bottom of the carton. The WAT tape head assemblies apply the water to the WAT tape and feed the WAT tape during application to the carton, while dual first and second top tape applicator assemblies and dual first and second bottom tape applicator assemblies are used to apply a double application of WAT tape to the carton.

### CROSS REFERENCE AND PRIORITY CLAIM UNDER 35 U.S.C. § 119

This application claims priority to U.S. Provisional Application No. 63/709,069 entitled “Water Activated Tape (WAT) Carton Sealing Apparatus with Top and Bottom Carton Feeding and Method of Carton Sealing” filed on Oct. 18, 2024, which is assigned to the assignee hereof and the entirety of which is incorporated by reference herein.

### FIELD

The present disclosure relates to an improved water activated tape (WAT) carton sealing apparatus, and assemblies thereof, and in particular, utilizing top and bottom feeder assemblies and/or other assemblies for decreasing the footprint of a WAT carton sealing apparatus and/or increasing the speed at which cartons may be sealed using WAT tape.

### BACKGROUND

Cartons being sealed using WAT carton sealing apparatuses that utilize WAT tape require a larger footprint and/or slower carton sealing speeds due to the traditional assemblies that are used within WAT carton sealing apparatuses. There is a need to provide WAT carton sealing apparatuses that can seal cartons with a smaller footprint and at higher speeds.

### SUMMARY

Embodiments of the present disclosure relate to a carton sealing apparatus that may automatically (e.g., fully, semi-automatically, or the like) dispense WAT tape for sealing cartons (e.g., otherwise described as boxes, packages, containers, or the like). As such, the WAT carton sealing apparatus may comprise a top carton sealing assembly and a bottom carton sealing assembly. As will be described in further detail herein, the top carton sealing assembly moves (e.g., vertically) with respect to the bottom carton sealing assembly in order to seal cartons of different heights and/or lengths. As will also be described in further detail herein, the top carton sealing assembly may comprise a top carton feeder assembly, a top tape applicator assembly, and/or a top WAT tape head assembly. The top feeder assembly is used to at least partially feed a carton through the carton sealing apparatus. The top WAT tape head assembly is used to apply the water to the WAT tape and/or feed the WAT tape during application to the carton, while the top tape applicator assembly is used to apply the WAT tape to the carton.

The bottom carton sealing assembly may comprise a bottom carton feeder assembly, a bottom tape applicator assembly, and/or a top WAT tape head assembly. The bottom carton feeder assembly is used to at least partially feed a carton through the carton sealing apparatus. The bottom WAT tape head assembly is used to apply the water to the WAT tape and/or feed the WAT tape during application to the carton, while the bottom tape applicator assembly is used to apply the WAT tape to the carton.

Utilizing a top carton feeder assembly and/or a bottom carton feeder assembly allows the carton to be feed through the carton sealing apparatus through contact with the top and/or bottom of the carton, which eliminates the need to drive the carton through contact with the sides of the carton (e.g., through side driven belts, or the like). As such, the top carton feeder assembly and/or bottom carton feeder assembly reduce the footprint of the carton sealing apparatus.

Moreover, as will be described in further detail herein, the top tape applicator assembly and/or the bottom tape applicator assembly may provide a double wipe down of the WAT tape being applied to the leading sides and/or trailing sides on both the top and bottom of the carton, using dual roller assemblies. For example, a top roller assembly comprising a top first dual roller assembly and a top second dual roller assembly, and a bottom roller assembly comprising a bottom first dual roller assembly and a bottom second dual roller assembly may be used to apply the WAT tape to the leading side, top flaps, and trailing side surfaces at the top of the carton and to the leading side, bottom flaps, and trailing side surfaces at the bottom of the carton. One or more of the rollers may be wobble rollers which may rotate around, as well as pivot, with respect to the axis of the roller to account for surfaces of the carton that may be out of plane. The top and/or bottom roller assemblies use dual roller assemblies to provide two wipe downs of the WAT tape at the top and bottom of the carton, which improves the adhesion of the WAT tape to the carton at higher speeds (e.g., re-applies tape that may peel off of the carton), as will be described in further detail herein.

Furthermore, the top WAT tape head assembly and/or the bottom WAT tape head assembly may include tape pinch roller assemblies that are configured to drive the movement of the WAT tape (e.g., as opposed to the movement of the carton pulling the WAT tape) at a speed that corresponds (e.g., the same or similar speed) with the carton that is being fed through the carton sealing apparatus. At least partially driving the WAT tape allows for the application of the WAT tape to the carton at high speeds while reducing unsuitable application (e.g., peeling, shifting, bunching, or the like) of the WAT tape as it is being applied to the carton.

Moreover, the WAT carton sealing apparatus may further comprise a top tape supply assembly and a bottom tape supply assembly. The top tape supply assembly may be located in-line with the application of the WAT tape to the carton (e.g., along the same axis), while the bottom tape supply assembly may be located adjacent to and/or under the WAT carton sealing apparatus (e.g., instead of being located in line) in order to reduce the footprint of the WAT carton sealing apparatus.

Furthermore, the WAT carton sealing apparatus may further comprise a water supply assembly that is used to deliver water to the top WAT tape head assembly and the bottom WAT tape head assembly. The water supply assembly may utilize one or more centralized tanks that provide water to a top water supply assembly and a bottom water supply assembly, which are configured to equalize the water supply to the WAT tape for improving the speed at which the WAT tape may be applied to the carton.

The WAT carton sealing apparatus further comprises a carton gate assembly that is utilized to control the timing of supplying the cartons to the WAT carton sealing apparatus for sealing.

As noted above, the various assemblies of the carton sealing apparatus, alone or in combination, provide a reduced footprint for the carton sealing apparatus and/or allow for the improved application of WAT tape to the carton at elevated speeds. These improvements reduce the amount of space that the carton sealing apparatus takes up within a facility and/or improves the number of cartons that can be sealed and shipped from the facility.

One embodiment of the invention is a carton sealing apparatus utilizing water activated tape (WAT) to seal a carton. The apparatus comprises a top carton sealing assembly comprising, a top carton feeder assembly, a top WAT tape head assembly, and a top applicator assembly. The apparatus comprises a bottom carton sealing assembly comprising a bottom carton feeder assembly, a bottom WAT tape head assembly, and a bottom applicator assembly. The carton is configured to be at least partially fed through the apparatus by the top carton sealing assembly contacting an upper surface of the carton and the bottom carton feeder assembly contacting a lower surface of the carton.

In further accord with embodiments, the top carton feeder assembly comprises a drive assembly comprising a drive roller, a motor, and two or more guide rollers, and a belt operatively coupled to the drive roller and the two or more guide rollers. The drive roller and at least one of the two or more guide rollers are offset vertically to provide a serpentine path for the belt, and the belt is configured to contact the upper surface of the carton to feed the carton through the apparatus.

In other embodiments, the top applicator assembly comprises a top roller assembly comprising a top first dual roller assembly comprising a top first leading tape leg roller and a top first trailing tape leg roller. The top roller assembly further comprises a top second dual roller assembly comprising a top second leading tape leg roller and a top second trailing tape leg roller.

In still other embodiments, the bottom applicator assembly comprises a bottom roller assembly comprising a bottom first dual roller assembly comprising a bottom first leading tape leg roller and a bottom first trailing tape leg roller. The bottom roller assembly comprises a bottom second dual roller assembly comprising a bottom second leading tape leg roller and a bottom second trailing tape leg roller.

In yet other embodiments, one or more of the top second leading tape leg roller, the top second trailing tape leg roller, the bottom second leading tape leg roller, or the bottom second trailing tape leg roller comprises a wobbly roller assembly. The wobbly roller assembly comprises an axle, a pivot connector operatively coupled to the axle, and a roller with an axle aperture therethrough extending over the axle and the pivot connector. The roller is configured to rotate around the axle and pivot with respect to an axle axis of the axle around the pivot connector.

In other embodiments, at least one of the top second dual roller assembly or the bottom second dual roller assembly comprises a deflector. The deflector is configured to guide a top leading tape leg or a bottom leading tape leg over the top second leading tape leg roller or the bottom second leading tape leg roller when the top leading tape leg or the bottom leading tape leg pop off of a leading side of the carton after application by the top first leading tape leg roller or the bottom first leading tape leg roller.

In further accord with embodiments, the top WAT tape head assembly or the bottom WAT tape head assembly comprise a tape feeder assembly comprising a tape motor, a driven tape roller operatively coupled to the tape motor, and a pinch roller. The driven tape roller and the pinch roller are configured to feed the tape at a speed that corresponds to a belt speed.

In other embodiments, the carton sealing apparatus further comprises a bottom tape supply assembly comprising a tape roll mandrel for supporting a tape roll, one or more guide rollers, and one or more turn members.

In still other embodiments, the tape roll mandrel is operatively coupled to a side of the carton sealing apparatus, and the tape roll operatively coupled to the tape roll mandrel is offset from a centerline of the carton sealing apparatus. Moreover, the one or more turn members comprise a first turn member to turn tape from the tape roll towards the centerline of the carton sealing apparatus, and a second turn member to turn the tape at the centerline of the carton sealing apparatus to the bottom WAT tape head assembly.

In yet other embodiments, the bottom tape supply assembly further comprises a tape roll storage assembly located under the carton sealing apparatus. The one or more turn members comprise a first member configured to turn the tape at a centerline of the carton sealing apparatus to the bottom WAT tape head assembly. Moreover, the tape roll storage assembly is configured to be retracted for storage under the carton sealing apparatus during operation and extended adjacent the carton sealing apparatus for supplying a new tape roll.

In other embodiments, the tape roll storage assembly comprises one or more tape roll tracks and one or more tape roll carriages operatively coupled to the one or more tape roll tracks. The mandrel is located on the one or more tape roll carriages.

In further accord with embodiments, the carton sealing apparatus further comprises a water supply assembly comprising one or more water supplies. The water supply assembly further comprises a top water supply assembly comprising a top water reservoir, a top reservoir input operatively coupling the top water reservoir with the one or more water supplies, a top reservoir output operatively coupling the top water reservoir with the one or more water supplies, and a top water pot conduit operatively coupling the top water reservoir with a top water pot in the top WAT tap head assembly. The water supply assembly further comprises a bottom water supply assembly comprising a bottom water reservoir, a bottom reservoir input operatively coupling the bottom water reservoir with the one or more water supplies, a bottom reservoir output operatively coupling the bottom water reservoir with the one or more water supplies, and a bottom water pot conduit operatively coupling the bottom water reservoir with a bottom water pot in the top WAT tap head assembly. The water supply assembly further comprises one or more pumps operatively coupled to the top reservoir input, the top reservoir output, the bottom reservoir input, and the bottom reservoir output. The one or more pumps circulate water between the top water reservoir and the one or more water supplies, and the bottom water reservoir and the one or more water supplies.

In other embodiments, the one or more water supplies comprise a water tank with a water volume for a top supply roll or a bottom supply roll.

In still other embodiments, the one or more pumps comprise one or more peristaltic pumps.

In yet other embodiments, the carton sealing apparatus further comprises a gate assembly comprising a gate member and a gate drive operatively coupled to the gate member. The gate drive is configured to rotate the gate member into a retracted position when the carton sealing apparatus is ready for sealing the carton. Moreover, the gate drive is configured to rotate the gate member into an extended position when the carton sealing apparatus is not ready for sealing the carton.

In other embodiments, the carton sealing apparatus further comprises one or more sensors and a controller. The controller comprises one or more memory components with computer-readable program code stored thereon, and one or more processing devices operatively coupled to the one or more memory devices. When executed the computer-readable program code is configured to cause the one or more processing components to identify the carton for sealing, and operate the carton sealing apparatus for sealing top flaps and bottom flaps of the carton.

In further accord with embodiments, when executed the computer-readable program code is further configured to cause the one or more processing components to identify when the carton is ready for sealing, determine a previous carton is still being sealed, and move the top carton sealing assembly upward to restrict the top carton feeder assembly from engaging the carton to restrict damage to the carton before sealing.

In other embodiments, when executed the computer-readable program code is further configured to cause the one or more processing components to receive a request to pass a sealed carton through the carton sealing apparatus, and move the top carton sealing assembly upwards to allow one or more cartons to pass through the carton sealing apparatus without sealing the one or more cartons with the tape.

In still other embodiments, the carton sealing apparatus seals cartons at speeds of over 100 ft/min.

To the accomplishment of the foregoing and the related ends, the one or more embodiments of the disclosure comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The drawings illustrate embodiments of the disclosure, and are not necessarily drawn to scale, wherein:

FIG. 1 is an entry end perspective view of a WAT carton sealing apparatus that is at least partially automated (e.g., semi-automated, fully-automated, or the like) and which may utilize one or more of the various assemblies described herein, including top and bottom carton sealing assemblies for moving and sealing the carton, in accordance with embodiments of the present disclosure.

FIG. 2 is an exit end perspective view of the WAT carton sealing apparatus of FIG. 1, in accordance with embodiments of the present disclosure.

FIG. 3A is a perspective view of a top carton sealing assembly having a top feeder assembly and top tape applicator assembly for a top of the carton with a portion of the top feeder assembly exposed, in accordance with embodiments of the present disclosure.

FIG. 3B is an enlarged perspective view of FIG. 3A illustrating the top feeder assembly exposed, in accordance with embodiments of the present disclosure.

FIG. 3C is an enlarged perspective view of FIG. 3A illustrating the top feeder assembly and top tape applicator assembly exposed, in accordance with embodiments of the present disclosure.

FIG. 3D is an enlarged upper perspective view of FIG. 3C illustrating the feeder drive of the top feeder assembly, in accordance with embodiments of the present disclosure.

FIG. 4A is a perspective view of a bottom carton sealing assembly having a bottom feeder assembly and bottom tape applicator assembly for a bottom of the carton with a portion of the bottom feeder assembly exposed, in accordance with embodiments of the present disclosure.

FIG. 4B is an enlarged perspective view of FIG. 4A illustrating the bottom feeder assembly exposed, in accordance with embodiments of the present disclosure.

FIG. 5A is a perspective view of the top tape applicator assembly exposed and the bottom tape applicator assembly exposed, in accordance with embodiments of the present disclosure.

FIG. 5B is an enlarged perspective view of the top tape applicator assembly having a top first dual roller assembly and a top second dual roller assembly, in accordance with embodiments of the present disclosure.

FIG. 5C is an enlarged perspective view of the bottom first dual roller assembly and a bottom second dual roller assembly, in accordance with embodiments of the present disclosure.

FIG. 5D is an enlarged perspective view of the top first dual roller assembly and the bottom first dual roller assembly, in accordance with embodiments of the present disclosure.

FIG. 5E is an enlarged perspective view of the top second dual roller assembly and the bottom second dual roller assembly, in accordance with embodiments of the present disclosure.

FIG. 6A is an enlarged perspective view of a wobble roller assembly that may be utilized in one or more of the applicator assemblies, in accordance with embodiments of the present disclosure.

FIG. 6B is an enlarged perspective view of the wobble roller assembly of FIG. 6A with a transparent roller illustrating the axle assembly, in accordance with embodiments of the present disclosure.

FIG. 6C is an enlarged perspective view of the wobble roller assembly of FIG. 6B with the roller removed illustrating the axle assembly, in accordance with embodiments of the present disclosure.

FIG. 7A is an enlarged perspective view of the top WAT tape head assembly, in accordance with embodiments of the present disclosure.

FIG. 7B is an enlarged perspective view of the top WAT tape head assembly, in accordance with embodiments of the present disclosure.

FIG. 7C is an enlarged perspective view of the top WAT tape head assembly with a portion of the tape separator assembly removed, in accordance with embodiments of the present disclosure.

FIG. 7D is an enlarged perspective view of the top WAT tape head assembly with a portion of the top WAT activator assembly removed illustrating the WAT pinch rollers of the tape drive assembly, in accordance with embodiments of the present disclosure.

FIG. 8A is an enlarged perspective view of the bottom WAT tape head assembly, in accordance with embodiments of the present disclosure.

FIG. 8B is an enlarged perspective view of the bottom WAT tape head assembly with a portion of the tape separator assembly removed, in accordance with embodiments of the present disclosure.

FIG. 8C is an enlarged perspective view of the bottom WAT tape head assembly with a portion of the WAT activator assembly removed illustrating the WAT pinch rollers of the tape drive assembly, in accordance with embodiments of the present disclosure.

FIG. 9A illustrates a perspective view of a bottom tape supply assembly located adjacent a side of the WAT carton sealing apparatus, in accordance with embodiments of the present disclosure.

FIG. 9B illustrates a top view of the bottom tape supply assembly, in accordance with embodiments of the present disclosure.

FIG. 9C illustrates a lower perspective view of the bottom tape supply assembly, in accordance with embodiments of the present disclosure.

FIG. 9D illustrates a lower perspective view of the bottom tape supply assembly that directs the tape towards the bottom WAT tape head assembly, in accordance with embodiments of the present disclosure.

FIG. 10A illustrates a perspective view of a bottom tape supply assembly located under WAT carton sealing apparatus, in accordance with embodiments of the present disclosure.

FIG. 10B illustrates a lower perspective view of the bottom tape supply assembly of FIG. 10A, in accordance with embodiments of the present disclosure.

FIG. 11A illustrates a schematic view of a water supply assembly, in accordance with embodiments of the present disclosure.

FIG. 11B illustrates a portion of the water supply assembly, in accordance with embodiments of the present disclosure.

FIG. 11C illustrates a top water supply assembly, in accordance with embodiments of the present disclosure.

FIG. 11D illustrates a bottom water supply assembly, in accordance with embodiments of the present disclosure.

FIG. 12A illustrates the top water supply assembly, in accordance with embodiments of the present disclosure.

FIG. 12B illustrates the bottom water supply assembly, in accordance with embodiments of the present disclosure.

FIG. 13A illustrates a carton gate assembly in an engaged position, in accordance with embodiments of the present disclosure.

FIG. 13B illustrates a carton gate assembly in a disengaged position, in accordance with embodiments of the present disclosure.

FIG. 14 illustrates a perspective view of a carton with the top tape and bottom tape applied, in accordance with embodiments of the present disclosure.

FIG. 15A is a perspective view of a tape roll with an outer layer and an adhesive layer that may be used as the WAT sealing tape, in accordance with embodiments of the present disclosure.

FIG. 15B is a cross-sectional view of the tape of FIG. 15A, in accordance with embodiments of the present disclosure.

FIG. 15C is a perspective view of a tape roll of reinforced tape that may be used as the WAT sealing tape, in accordance with embodiments of the present disclosure.

FIG. 15D is a cross-sectional view of the tape of FIG. 15C, in accordance with embodiments of the present disclosure.

FIG. 16 illustrates a controller that operates the WAT carton sealing apparatus, in accordance with embodiments of the present disclosure.

FIG. 17 illustrates a process for the operation of the WAT carton sealing apparatus, in accordance with embodiments of the present disclosure.

### DETAILED DESCRIPTION

Embodiments of the present disclosure now may be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure may satisfy applicable legal requirements. Like numbers refer to like elements throughout.

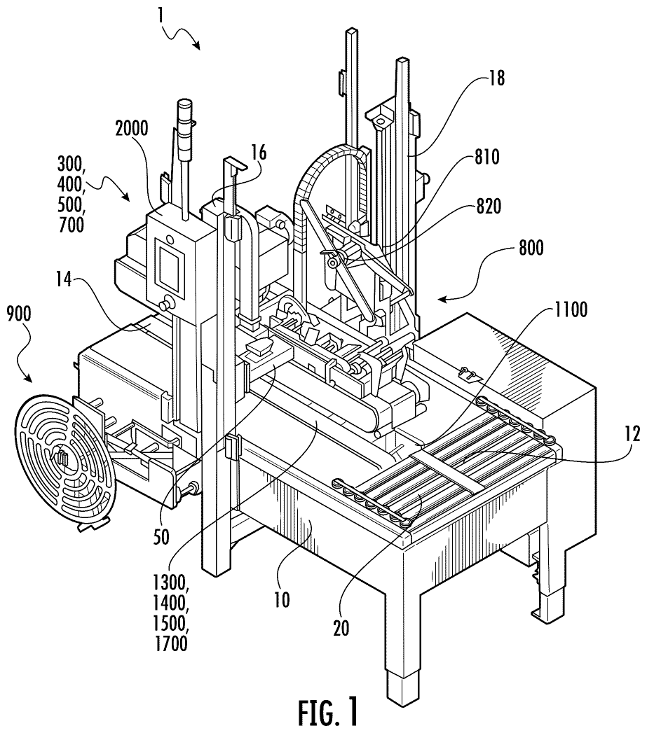

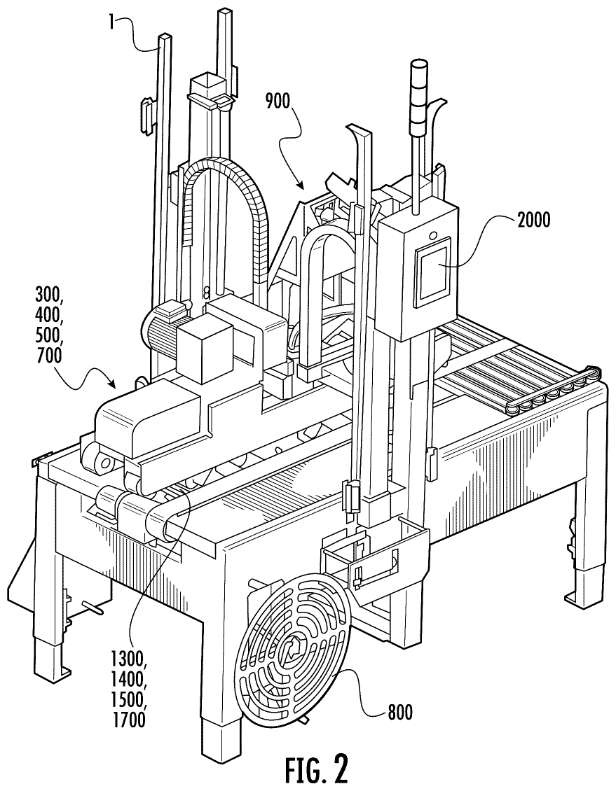

FIGS. 1 and 2 illustrate an embodiment of a carton sealing apparatus 1 that may automatically (e.g., fully, semi-automatically, or the like) dispense tape for sealing cartons 100 (e.g., otherwise described as boxes, packages, containers, or the like). These apparatuses 1 may dispense any type of tape, but in particular, may dispense water-activated tape (WAT), or other types of tape. As will be described in further detail herein, an aqueous solution (e.g., water, water with alcohol, or other water-based composition) is applied to the adhesive layer of the WAT tape in order to activate the adhesive layer for application to a carton 100. As such, when describing the use of water herein, it should be understood that the term water includes any type of aqueous solution that includes water alone or with other constituents that may form different types of water-based compositions.

While the apparatuses 1, and the various assemblies utilized within the apparatuses 1, may utilize various types of tape, the embodiments of the present disclosure will be illustrated and discussed with respect to a WAT carton sealing apparatus 1 that utilizes water activated (WAT) tape as the sealing tape. As such, at least some of the assemblies described herein will be specific to WAT carton sealing apparatuses 1 (e.g., water supply assembly 1000, or the like); however, at least some of the assemblies described herein may be utilized on other types of carton sealing apparatuses (e.g., carton sealing apparatuses that utilized pressure-sensitive tape, or other types of tape). Consequently, the present disclosure is not limited to WAT carton sealing apparatuses 1.

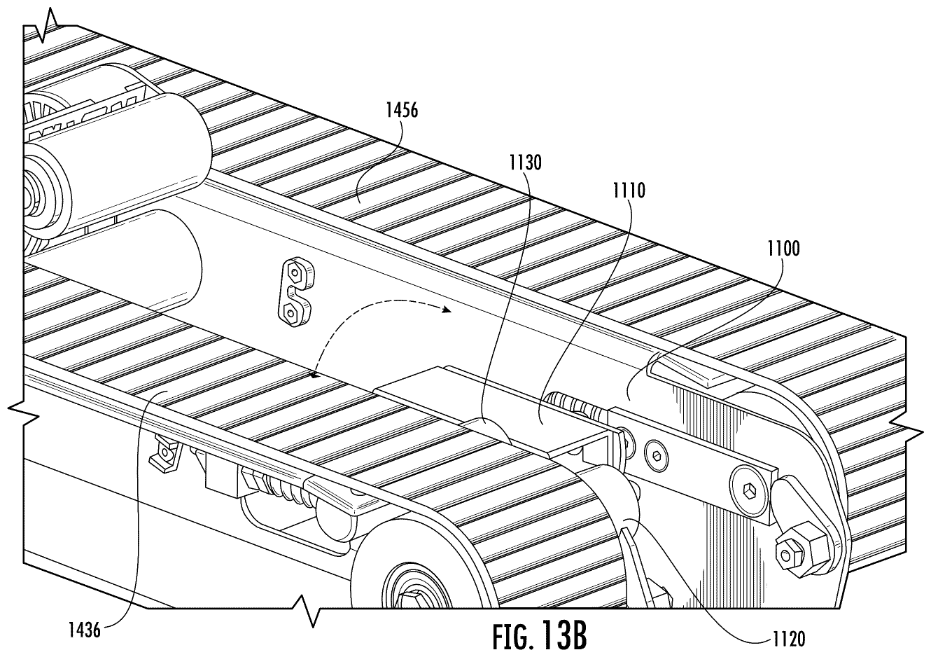

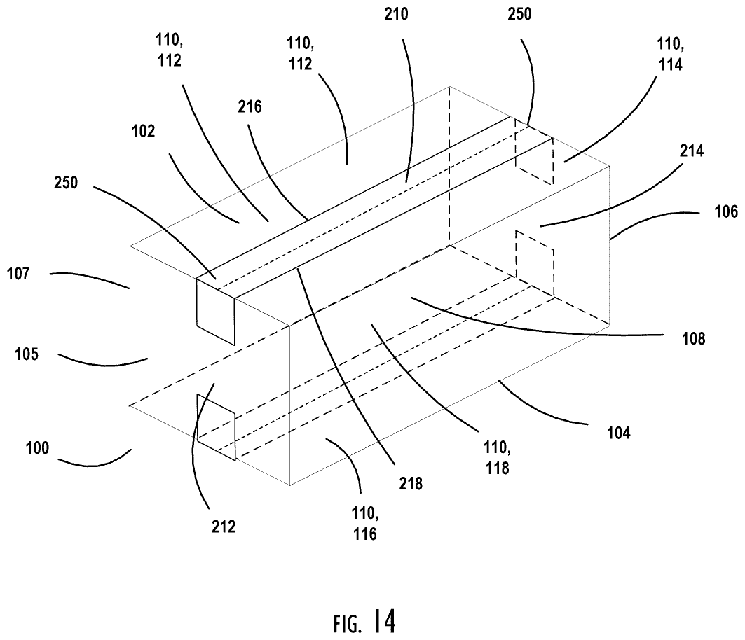

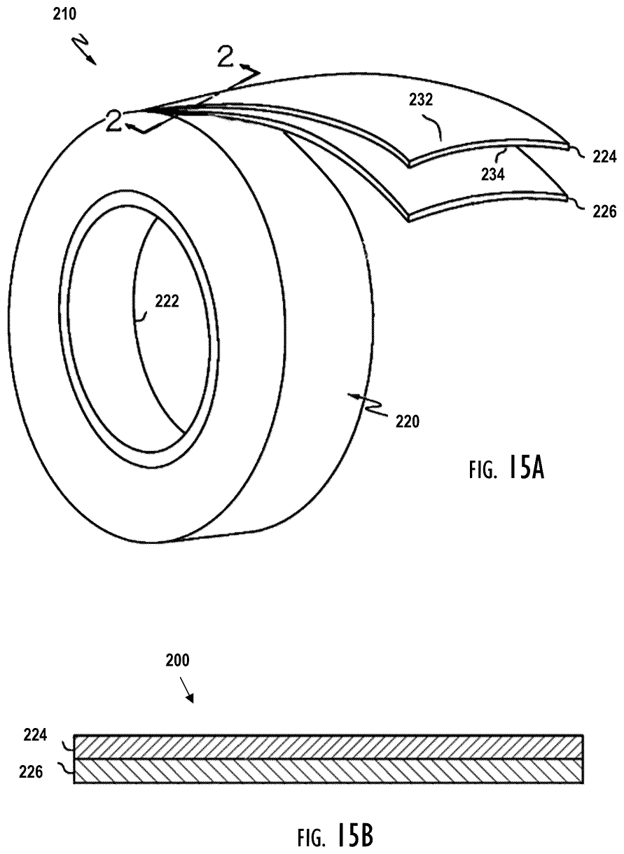

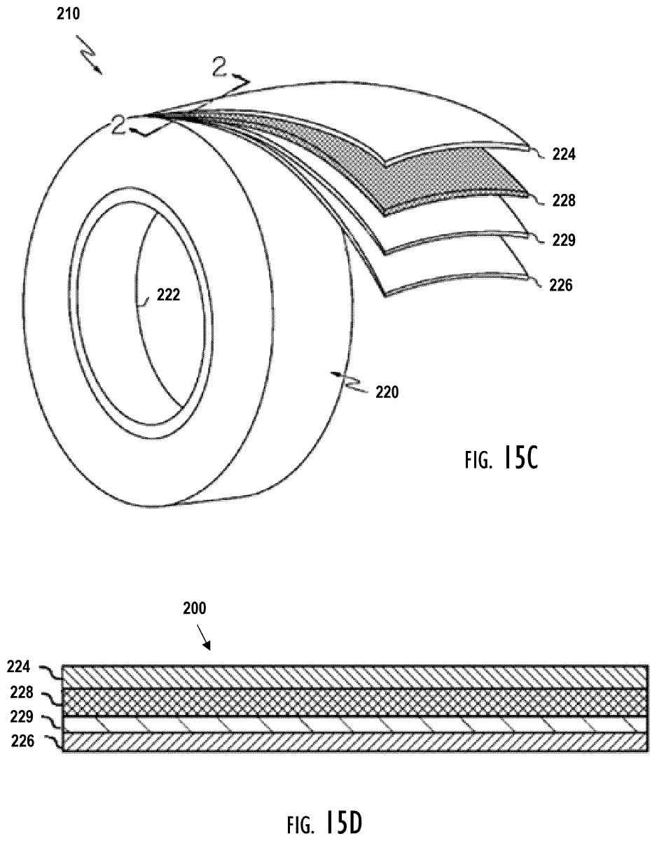

It should be further understood that a semi-automated WAT carton sealing apparatus 1, as illustrated in FIG. 1, automatically dispenses the WAT tape after the carton is placed adjacent the entry side 12 of the WAT carton sealing apparatus 1. As such, the semi-automated WAT carton sealing apparatus 1 seals the carton 100 after a user unfolds a carton blank, packs the carton, and/or folds the upper flaps of the carton 100. Alternatively, an automated WAT carton sealing apparatus 1 may automatically unfold a carton blank into a carton 100, supply the product to be packaged, and/or automatically fold the flaps of the carton 100. Consequently, an automated WAT carton sealing apparatus may at least fold the flaps of a carton 100 before the carton 100 is sealed, while the semi-automated WAT carton sealing apparatus 1 may at least require a user to fold the flaps of the carton 100 before the carton is sealed. The carton 100 being sealed and the types of WAT tape 200 will be described in further detail herein with respect to FIGS. 14 and 15A through 15D.

Finally, while various assemblies are described as being separate assemblies, it should be understood that each assembly may be further broken down into smaller assemblies or may be separate parts of a larger assembly. As such, an assembly may be broken down into two or more assemblies, or components thereof, or may be combined with another assemblies, or components thereof to form a larger assembly. It should be understood that such combinations are within the scope of the embodiments contemplated by the present disclosure.

FIGS. 1 and 2 illustrate one embodiment of a WAT carton sealing apparatus 1 (otherwise described as a carton sealing apparatus 1), and at least partial views of the various assemblies thereof. As such, the WAT carton sealing apparatus 1, may comprise a top carton sealing assembly 300 and a bottom carton sealing assembly 1300. As will be described in further detail herein, the top carton sealing assembly 300 moves (e.g., vertically) with respect to the bottom carton sealing assembly 1300 in order to seal cartons 100 of different heights and/or lengths. As will also be described in further detail herein, the top carton sealing assembly 300 may comprise a top carton feeder assembly 400, a top tape applicator assembly 500, and/or a top WAT tape head assembly 700. The top feeder assembly 400 is used to at least partially feed a carton 100 through the carton sealing apparatus 1. The top WAT tape head assembly 700 is used to apply the water to the WAT tape 200 and/or feed the WAT tape 200 during application to the carton 100, while the top tape applicator assembly 500 is used to apply the WAT tape 200 to the carton 100 (e.g., using rollers).

The bottom carton sealing assembly 1300 may comprise a bottom carton feeder assembly 1400, a bottom tape applicator assembly 1500, and/or top WAT tape head assembly 1700. The bottom carton feeder assembly 1400 is used to at least partially feed a carton 100 through the carton sealing apparatus 1. The bottom WAT tape head assembly 1700 is used to apply the water to the WAT tape 200 and/or feed the WAT tape 200 during application to the carton 100, while the bottom tape applicator assembly 1500 is used to apply the WAT tape 200 to the carton 100 (e.g., using rollers).

Utilizing a top carton feeder assembly 400 and/or a bottom carton feeder assembly 1400 allows the carton 100 to be feed through the carton sealing apparatus 1 through contact with the top and/or bottom of the carton 100, which eliminates the need to drive the carton 100 through contact with the sides of the carton 100 (e.g., through side driven belts, or the like). As such, the top carton feeder assembly 400 and/or bottom carton feeder assembly 1400 reduce the footprint of the carton sealing apparatus 1 and/or provide other benefits that will be described in further detail herein.

Moreover, as will be described in further detail herein, the top tape applicator assembly 500 and/or the bottom tape applicator assembly 1500 may provide a double wipe down of the WAT tape 200 being applied to the leading sides and/or trailing sides on both the top and bottom of the carton 100, using dual roller assemblies. For example, a top roller assembly 502 comprises a top first dual roller assembly 510 and a top second dual roller assembly 540, and a bottom roller assembly 1502 comprises a bottom first dual roller assembly 1510 and a bottom second dual roller assembly 1540. These assemblies 510, 540, 1510, 1540 may be used to apply the WAT tape 200 to the leading side, top flaps, and trailing side surfaces at the top of the carton 100 and to the leading side, bottom flaps, and trailing side surfaces at the bottom of the carton 100. One or more of the rollers may utilize a wobble roller assembly 600 that uses a wobble roller 630 which may rotate and pivot (e.g., wobble) with respect to the axis 610 and a pivot connector 620 to account for surfaces of the carton 100 that may be out of plane. The top and/or bottom roller assemblies 502, 1502 may use dual roller assemblies 510, 540, 1510, 1540 to provide two wipe downs of the WAT tape 200 at the top and bottom of the carton 100, which improves the adhesion of the WAT tape 200 to the carton 100 at higher speeds (e.g., re-applies tape that may peel off of the carton 100), as will be described in further detail herein.

Furthermore, the top WAT tape head assembly 700 and/or the bottom WAT tape head assembly 1700 may include tape pinch roller assemblies 730, 1730 that are configured to drive the movement of the WAT tape 200 (e.g., as opposed to the movement of the carton 100 pulling the WAT tape 100) at a speeds that correspond (e.g., the same or similar speed) with the carton 100 that is being fed through the WAT carton sealing apparatus 1. At least partially driving the WAT tape 200 allows for the application of the WAT tape 200 to the carton 100 at high speeds while reducing improper adhesion (e.g., peeling, shifting, bunching, or the like) of the WAT tape 200 as it is being applied to the carton 100, as will be described in further detail herein.

Moreover, as further illustrated in FIGS. 1 and 2, the WAT carton sealing apparatus 1 may further comprise a top tape supply assembly 800 and a bottom tape supply assembly 900.

The top tape supply assembly 800 may be located in line with the application of the WAT tape 200 to the carton 100 (e.g., along the same axis); however, the bottom tape supply assembly 900 may be located adjacent to and/or under the WAT carton sealing apparatus 1 (e.g., instead of being located in line) in order to reduce the footprint of the WAT carton sealing apparatus 1, as will be described in further detail herein.

Furthermore, the WAT carton sealing apparatus 1 may further comprise a water supply assembly 1000 that is used to deliver water to the top WAT tape head assembly 700 and the bottom WAT tape head assembly 1700. The water supply assembly 1000 may utilize one or more centralized tanks 1010 that provide water to a top water supply assembly 1020 and a bottom water supply assembly 1050, which are configured to equalize the water supply to the WAT tape 200 for improving the speed at which the WAT tape 200 may be applied to the carton 100 by providing the optimized and consistent wetting of the WAT tape 200, as will be described in further detail herein.

The WAT carton sealing apparatus 1 further comprises a carton gate assembly 1100 that is utilized to control the timing of supplying the cartons 100 to the WAT carton sealing apparatus 1 for sealing, which will restrict (e.g., reduce, prevent, or the like) the carton 100 from being damaged and/or the WAT tape 200 from being improperly applied to the carton 100, as will be described in further detail herein.

As noted above, the various assemblies of the carton sealing apparatus 1, alone or in combination, provide a reduced footprint for the WAT carton sealing apparatus 1 and/or allow for the improved application of WAT tape 200 to the carton 100 at elevated speeds. These improvements reduce the amount of space that the carton sealing apparatus 1 takes up within a facility and/or improves the number of cartons 100 that can be sealed and shipped from the facility.

As illustrated in FIGS. 1 and 2, the carton sealing apparatus 1 comprises a table 10, with an entry side 12 and an exit side 14. The table 10 may comprise an entry side carton centering assembly 20 that actuates to move the carton 100 to a centerline of the carton sealing apparatus 1 at the entry side 12 of the carton sealing apparatus 1. Moreover, the carton sealing apparatus 1 comprises a bottom carton sealing assembly 1300 operatively coupled to the table 10 and a top carton sealing assembly 300 operatively coupled to table supports 16, 18 that are operatively coupled to the table 10. The top carton sealing assembly 300 is moveable (e.g., vertically, or the like) with respect to the bottom carton sealing assembly 1300. It should be understood that the top carton sealing assembly 300 may move vertically through the use of any type of structure or drive system. However, in some embodiments, the carton sealing apparatus 1 may comprise a top carriage 50 (e.g., support members, or the like, otherwise described as a bridge) to which the top carton sealing assembly 300 is operatively coupled. The top carriage 50 may move vertically through the use of carriage guides (e.g., rollers, pads, bearings, or the like) that are operatively coupled to a track (e.g., bar, member with a cavity, or the like) that is operatively coupled to the table supports 14, 16. Carriage drives (e.g., motor, actuator - hydraulic, pneumatic, or the like drive) may be used with carriage drive trains (e.g., actuator arms, gears, pullies, or the like) to allow for vertical movement of the top carton sealing assembly 300. In particular embodiments, the carriage drive includes pneumatic cylinders that are used to move the top carton sealing assembly 300 vertically to allow for cartons 100 having different heights, such that the top carton sealing assembly 300 engages the top of the carton 100.

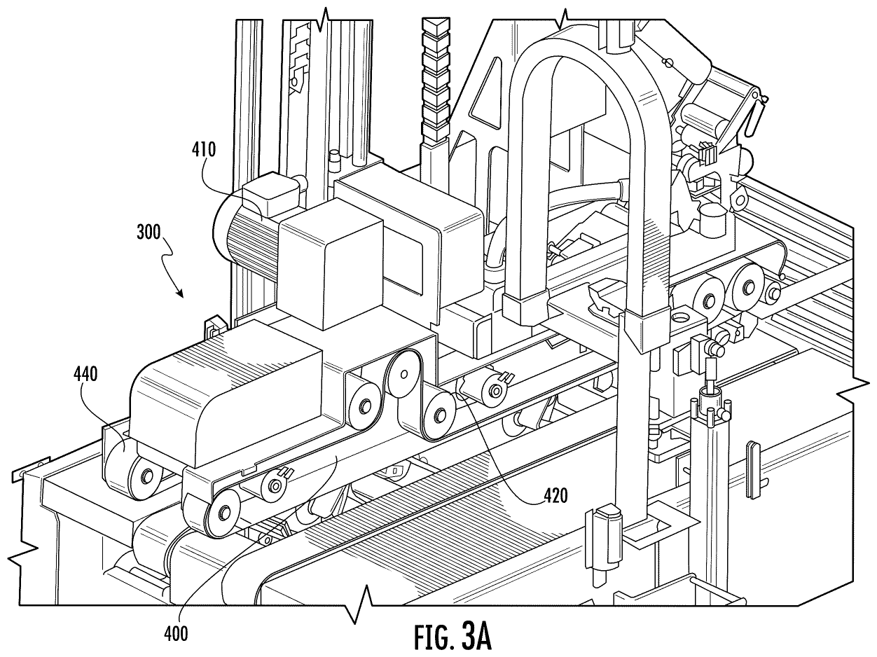

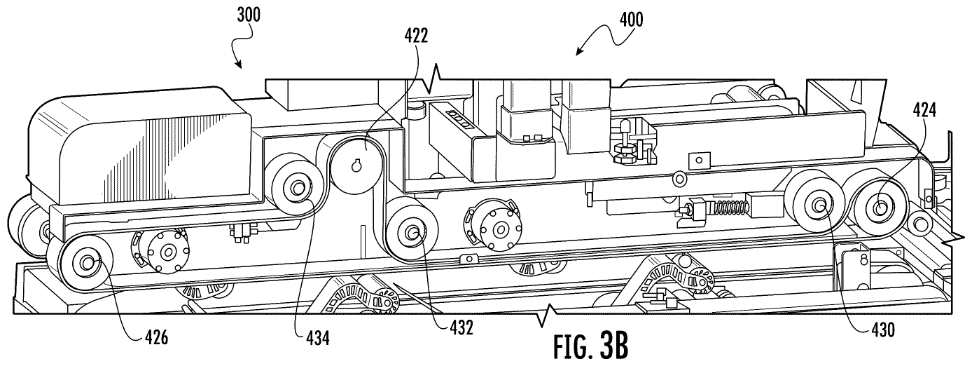

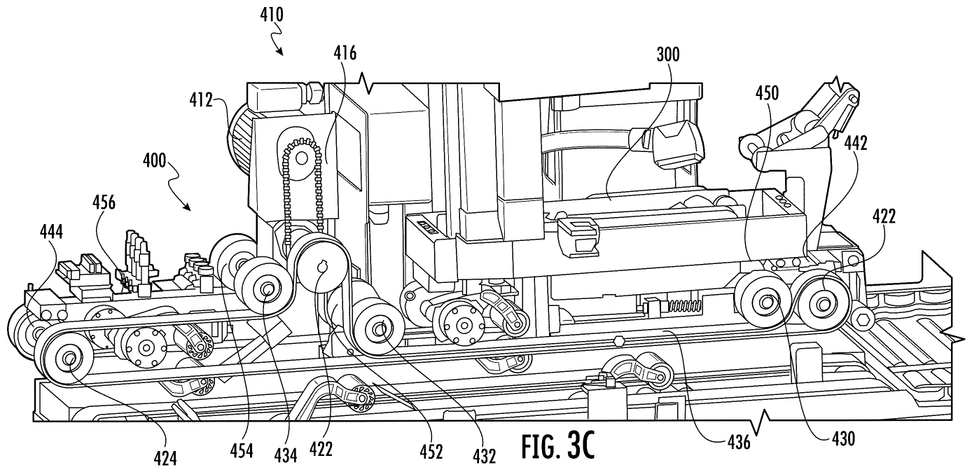

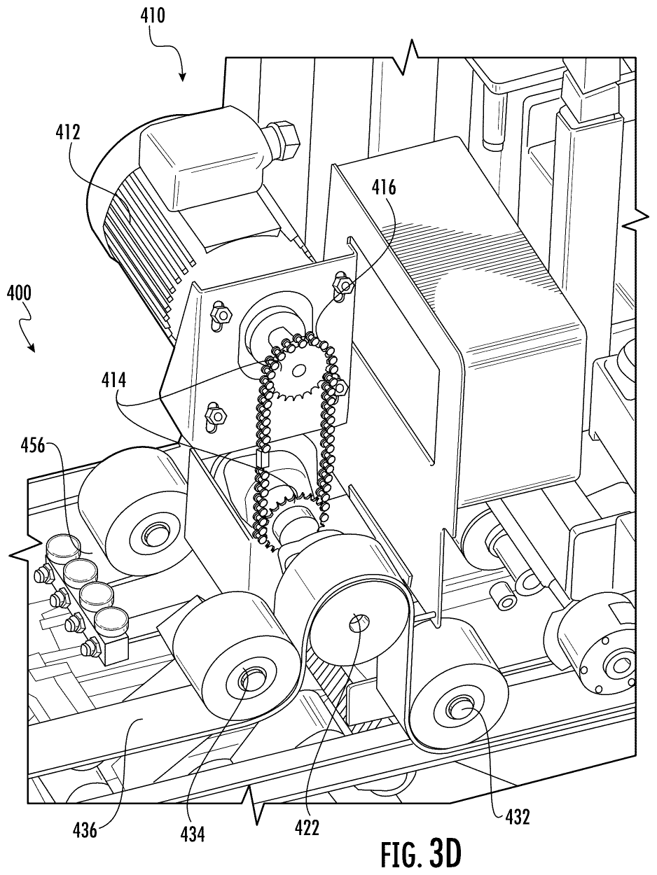

Turning to the specific assemblies of the carton sealing apparatus 1, FIGS. 3A through 3D illustrate a top carton feeder assembly 400 of the top carton sealing apparatus 300. The top carton feeder assembly 400 comprises a top carton drive assembly 410 comprising a motor 412 (or another type of drive), one or more drive trains 414 (e.g., gears, or the like), one or more flexible drive members 416 (e.g., a belt, chain, or the like). Moreover, the top carton feeder assembly 400 may further comprise a first top feeder assembly 420 and a second top feeder assembly 440. The first top feeder assembly 420 comprises a first drive roller 422 operatively coupled to the drive assembly 410, one more first top guide rollers, such as a first entry guide roller 424, a first top exit guide roller 426, two or more first intermediate serpentine top guide rollers, such as a first top intermediate entry guide roller 430, a first top center intermediate guide roller 432, and a first top intermediate exit guide roller 434. A first flexible feeder member 436 (e.g., a belt, or the like) is operatively coupled to (e.g., wrapped around, or the like) the first top drive roller 422 and/or the two or more guide rollers 424, 424, 426, 428, 430, 432, 434 in a serpentine configuration.

It should be further understood that the a second top feeder assembly 440 comprises the second top drive roller 442 operatively coupled to the drive assembly 410, one more second top guide rollers, such as a second top entry guide roller 444, a second top exit guide roller 446, two or more second intermediate serpentine top guide rollers, such as a second top intermediate entry guide roller 450, a second top center intermediate guide roller 452, and a second top intermediate exit guide roller 454. A second flexible feeder member 456 (e.g., a belt, or the like) is operatively coupled to the second top drive roller 442 and/or the two or more guide rollers 444, 446, 450, 452, 454 in a serpentine configuration.

The first top feeder assembly 420 and the second top feeder assembly 440 are spaced apart and have the serpentine configurations to allow for inclusion of the drive assembly 410, as well as a top WAT tape head assembly 700 and a top applicator assembly 500 as will be described and illustrated in further detail below. As such, the first top feeder assembly 420 and the second top feeder assembly 440 allow for reducing the footprint of the carton sealing apparatus 1 while still providing the elevated speeds achieved by the carton sealing apparatus 1, which will be described in further detail herein.

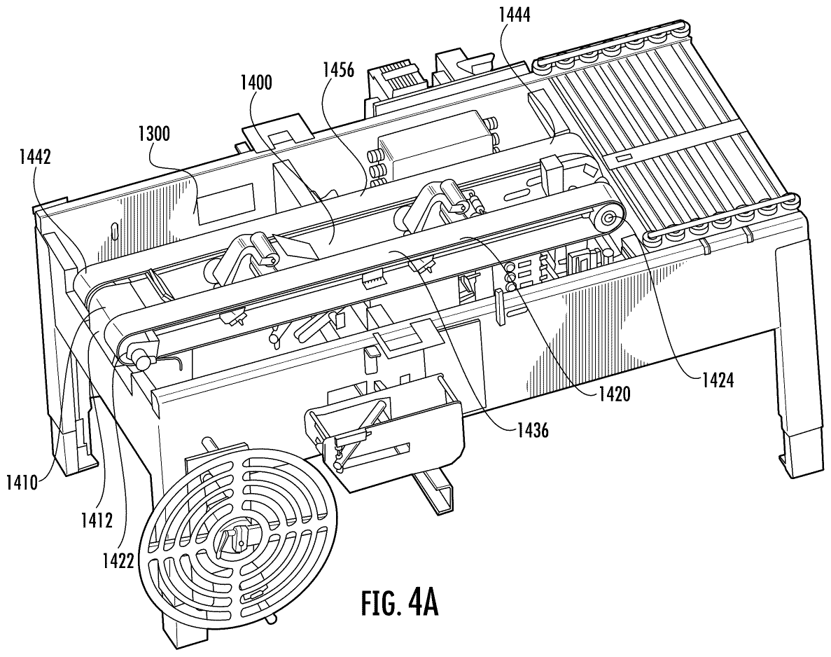

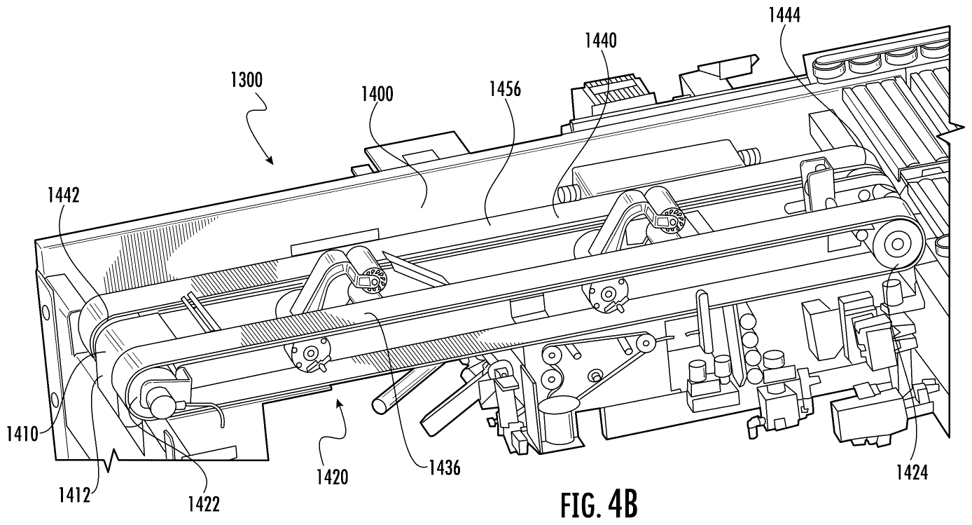

FIGS. 4A through 4B illustrate a bottom feeder assembly 1400 of the bottom carton sealing apparatus 1300. It should be understood that the first bottom feeder assembly 1420 and the second bottom feeder assembly 1440 of the bottom feeder assembly 1400 may have the same (e.g., serpentine) or different configuration (e.g., linear) as the first top feeder assembly 420 and the second top feeder assembly 440 of the top carton feeder assembly 400. In the illustrated embodiment, the bottom carton feeder assembly 1400 comprises a bottom carton drive assembly 1410 comprising one or more motors 1412 that are operatively coupled directly to the drive rollers 1422, 1442. However, in some embodiments, the bottom carton drive assembly 1410 further comprises one or more drive trains (e.g., gears, or the like), and one or more flexible drive members (e.g., a belt, chain, or the like). Moreover, the bottom carton drive assembly 1400 may further comprise a first bottom feeder assembly 1420 and a second bottom feeder assembly 1440. The first bottom feeder assembly 1420 comprises a first drive roller 1422 operatively coupled to the bottom carton drive assembly 1410, and one more first guide rollers, such as a first entry guide roller 1424. A first bottom flexible feeder member 1436 (e.g., a belt, or the like) is operatively coupled to (e.g., wrapped around, or the like) the first bottom drive roller 1422 and/or the first entry guide roller 1424. While the drive roller 1422 is located at the exit side 14 and the guide roller 1424 is located at the entry side 12, it should be understood that these rollers, and thus the bottom carton drive assembly 1410 may be switched to the opposite sides of the table 10 or may be located anywhere therebetween.

It should be further understood that the second bottom feeder assembly 1440 comprises the second bottom drive roller 1442 operatively coupled to the bottom drive assembly 1410, and one more second bottom guide rollers, such as a second entry guide roller 1444. A second bottom flexible feeder member 1456 (e.g., a belt, or the like) is operatively coupled to (e.g., wrapped around, or the like) the second bottom drive roller 1442 and/or the second entry guide roller 1444. While the drive roller 1442 is located at the exit side 14 and the guide roller 1444 is located on the entry side 12, it should be understood that these rollers, and thus the bottom carton drive assembly 1410 may be switched to the opposite sides of the table 10 or may be located anywhere therebetween. The first bottom feeder assembly 1420 and the second bottom feeder assembly 1440 allow for reducing the footprint of the carton sealing apparatus 1 while still providing the elevated speeds achieved by the carton sealing apparatus 1, which will be described in further detail herein.

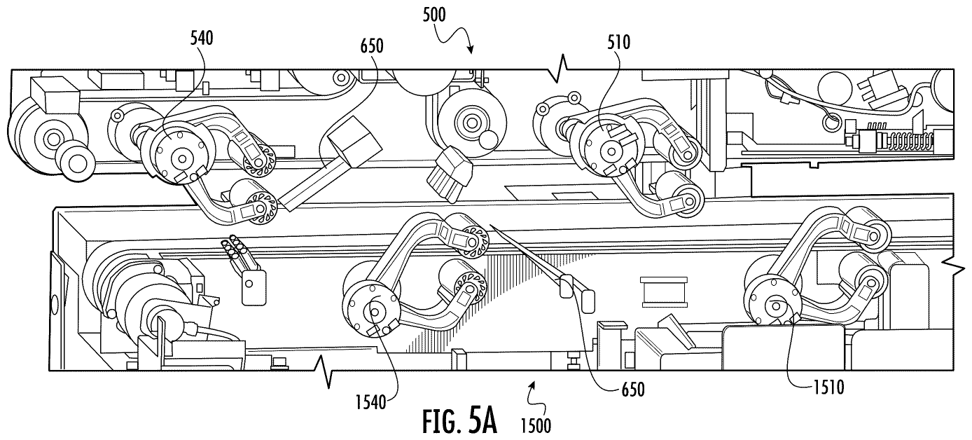

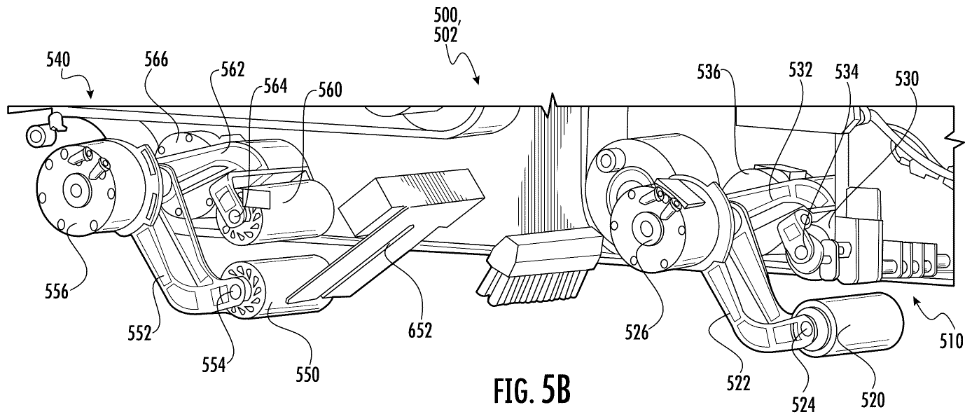

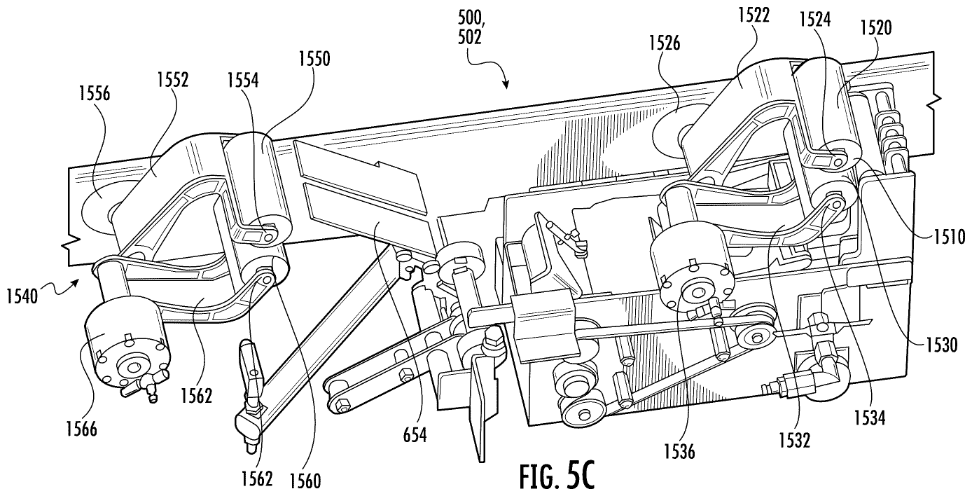

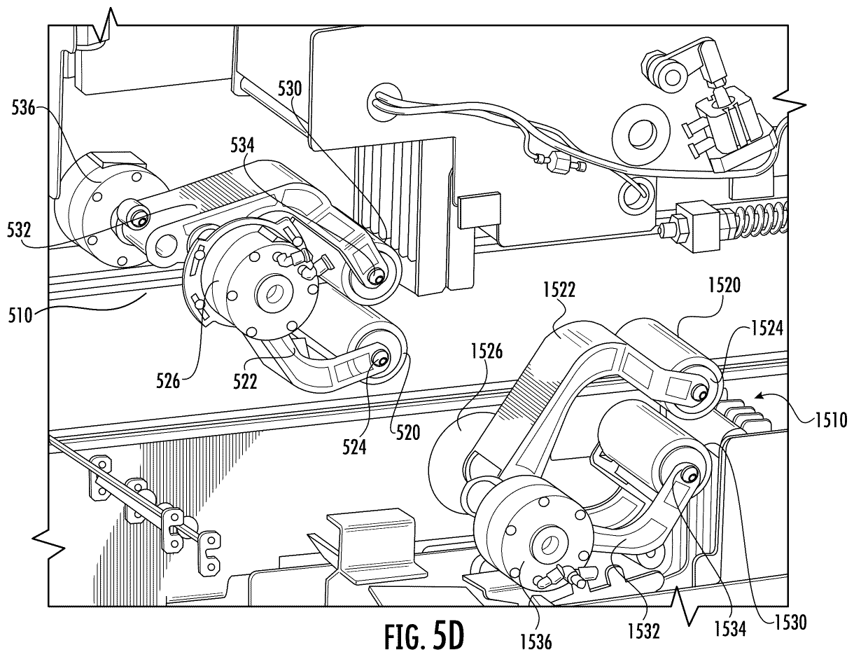

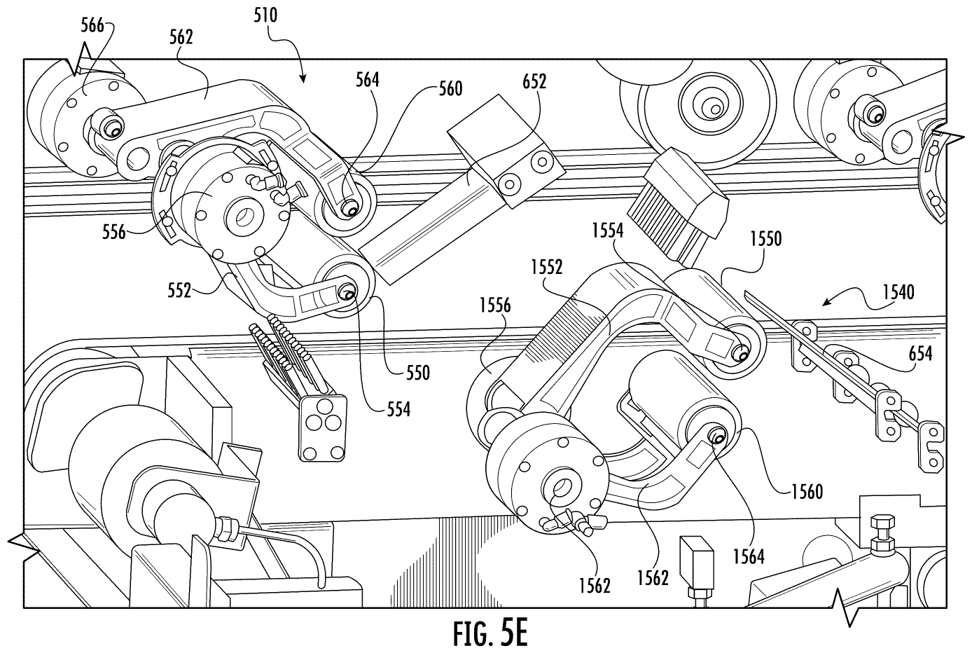

FIGS. 5A through 5E provide perspective views of the top tape applicator assembly 500 and the bottom tape applicator assembly 1500. The top applicator assembly 500 comprises a top roller assembly 502 comprising a top first dual roller assembly 510 and a top second dual roller assembly 540. The top first dual roller assembly 510 comprises a top first leading tape leg roller 520 and the top first trailing tape leg roller 530. The top first leading tape leg roller 520 is operatively coupled to a top first leading tape leg arm 522 through a roller axle 524 that allows the top first leading tape leg roller 520 to rotate around the axle 524. Moreover, the top first leading tape leg arm 522 is operatively coupled to a top first leading tape leg drive 526 (e.g., motor, hydraulic, pneumatic, or the like drive) that allows the top first leading tape leg arm 522 to rotate during application of the WAT tape 200 to the carton 100 and return to its original position. The top first trailing tape leg roller 530 is operatively coupled to a top first trailing tape leg arm 532 through a roller axle 534 that allows the top first trailing tape leg roller 530 to rotate. Moreover, the top first trailing tape leg arm 532 is operatively coupled to a top first trailing tape leg drive 536 that allows the top first trailing tape leg arm 532 to rotate during application of the WAT tape 200 to the carton 100 and return to its original position.

Similar to the top first dual roller assembly 510, the top second dual roller assembly 540 comprises a top second leading tape leg roller 550 and the top second trailing tape leg roller 560. The top second leading tape leg roller 550 is operatively coupled to a top second leading tape leg arm 552 through a roller axle 554 that allows the top second leading tape leg roller 550 to rotate around the axle 554. Moreover, the top second leading tape leg arm 552 is operatively coupled to a top second leading tape leg drive 556 that allows the top second leading tape leg arm 552 to rotate during application of the WAT tape 200 to the carton 100 and return to its original position. The top second trailing tape leg roller 560 is operatively coupled to a top second trailing tape leg arm 562 through a roller axle 564 that allows the top second trailing tape leg roller 560 to rotate around the axle 564. Moreover, the top second trailing tape leg arm 562 is operatively coupled to a top second trailing tape leg drive 566 that allows the top second trailing tape leg arm 562 to rotate during application of the WAT tape 200 to the carton 100 and return to its original position.

Similar to the top applicator assembly 500, the bottom applicator assembly 1500 comprises a bottom roller assembly 1502 comprising a bottom first dual roller assembly 1510 and a bottom second dual roller assembly 1540. The bottom first dual roller assembly 1510 comprises a bottom first leading tape leg roller 1520 and the bottom first trailing tape leg roller 1530. The bottom first leading tape leg roller 1520 is operatively coupled to a bottom first leading tape leg arm 1522 through a roller axle 1524 that allows the bottom first leading tape leg roller 1520 to rotate around the axle 1524. Moreover, the bottom first leading tape leg arm 1522 is operatively coupled to a bottom first leading tape leg drive 1526 that allows the bottom first leading tape leg arm 1522 to rotate during application of the WAT tape 200 to the carton 100 and return to its original position. The bottom first trailing tape leg roller 1530 is operatively coupled to a bottom first trailing tape leg arm 1532 through a roller axle 1534 that allows the bottom first trailing tape leg roller 1530 to rotate. Moreover, the bottom first trailing tape leg arm 1532 is operatively coupled to a bottom first trailing tape leg drive 1536 that allows the bottom first trailing tape leg arm 1532 to rotate during application of the WAT tape 200 to the carton 100 and return to its original position.

Similar to the bottom first dual roller assembly 1510, the bottom second dual roller assembly 1540 comprises a bottom second leading tape leg roller 1550 and the bottom second trailing tape leg roller 1560. The bottom second leading tape leg roller 1550 is operatively coupled to a bottom second leading tape leg arm 1552 through a roller axle 1554 that allows the bottom second leading tape leg roller 1550 to rotate around the axle 1554. Moreover, the bottom second leading tape leg arm 1552 is operatively coupled to a bottom second leading tape leg drive 1556 that allows the bottom second leading tape leg arm 1552 to rotate during application of the WAT tape 200 to the carton 200 and return to its original position. The bottom second trailing tape leg roller 1560 is operatively coupled to a bottom second trailing tape leg arm 1562 through a roller axle 1564 that allows the bottom second trailing tape leg roller 1560 to rotate around the axle 1564. Moreover, the bottom second trailing tape leg arm 1562 is operatively coupled to a bottom second trailing tape leg drive 1566 that allows the bottom second trailing tape leg arm 1562 to rotate during application of the WAT tape 200 to the carton 100 and return to its original position.

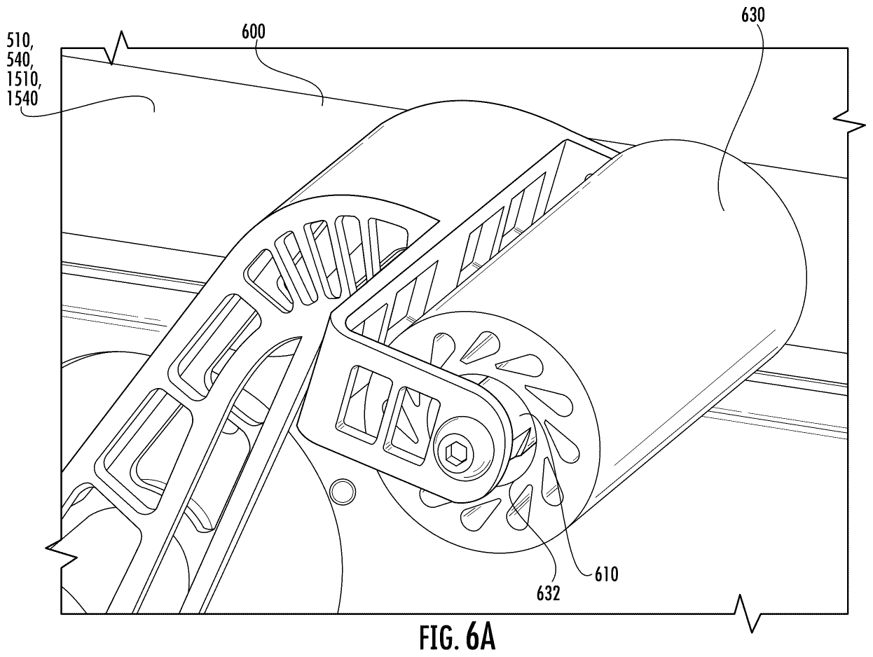

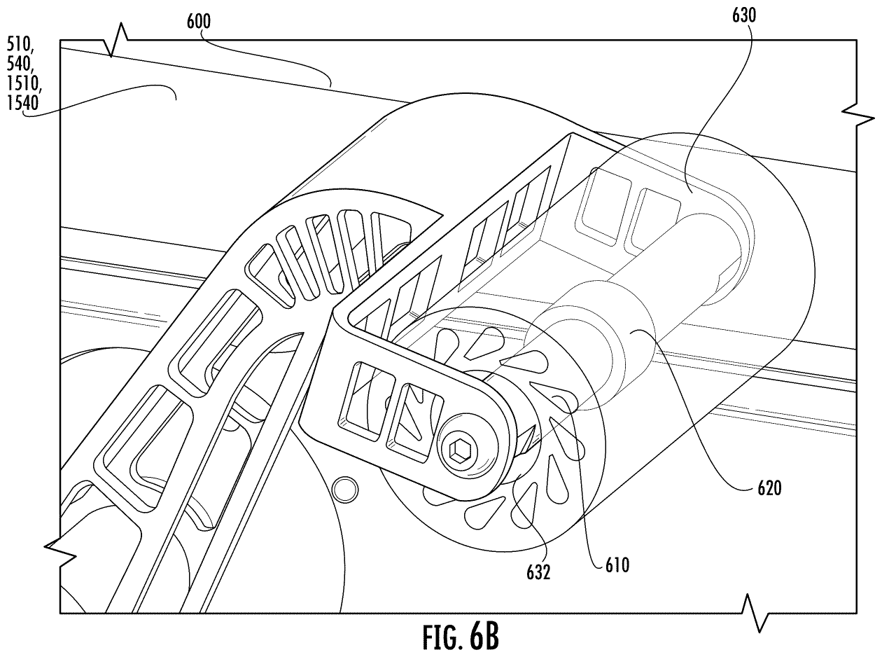

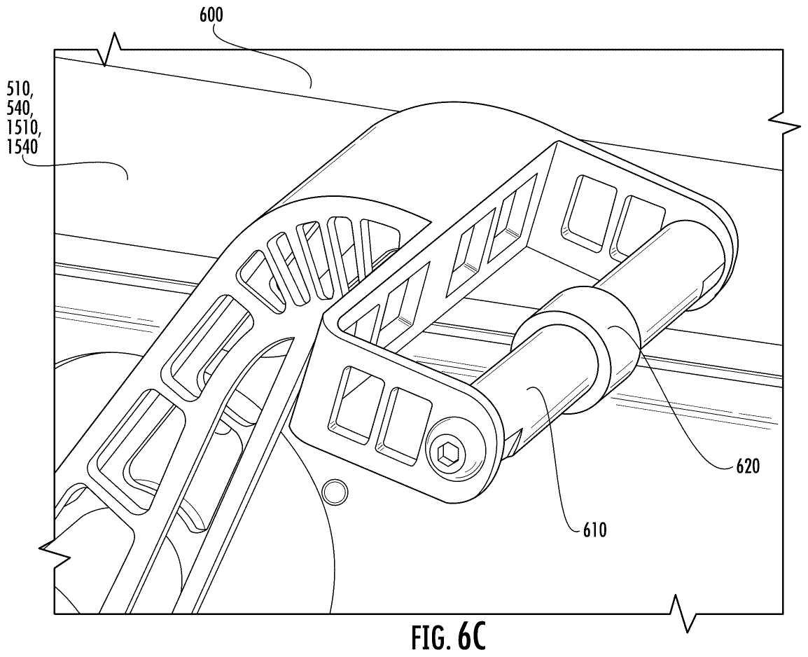

In some embodiments, the top first dual roller assembly 510, the top second dual roller assembly 540, the bottom first dual roller assembly 1510, and/or the bottom second dual roller assembly 1540 may comprise a wobbly roller assembly 600, as illustrated in FIGS. 6A through 6C. In particular embodiments, the wobbly roller assembly 600 may be utilized for the top second dual roller assembly 540 and the bottom second dual roller assembly 1540. The wobbly roller assembly 600 may comprise an axle 610, a pivot connector 620 operatively coupled to the axle 610, and a roller 630 with an axle aperture 632 therethrough extending over the axle 610 and the pivot connector 620. The roller 630 is configured to rotate around the axle 610 and pivot with respect to an axle axis of the axle 610 around the pivot connector 620. The wobbly roller assembly 600 allows the rollers, in particular, the one or more rollers of the top second dual roller assembly 540 and the bottom second dual roller assembly 1540 to have improved contact when applying the WAT tape 200 to the carton 100 in the event that the carton 100 is out of plane, such as due to being deformed, damaged, over packed, under packed, assembled out of plane, or the like.

Moreover, as illustrated in FIGS. 5A through 5D, the top second dual roller assembly 540 and the bottom second dual roller assembly 1540 may further comprise one or more deflectors 650, such as a lower deflector 652 and an upper deflector 654. The one or more deflectors 650 are configured to guide the top leading tape leg or the bottom leading tape leg over the top second leading tape leg roller 550 or the bottom second leading tape leg roller 1550 when the top leading tape leg or the bottom leading tape leg pops off of a leading side of the carton 100 after application by the top first leading tape leg roller 520 or the bottom first leading tape leg roller 1520. The deflectors 650 deflect the tape 200 into the proper location so that the tape 200 is restricted from (e.g., reduce, prevent, or the like) winding around the rollers and peeling off the carton 200 should the tape legs pop-off of the carton 100. Moreover, in some embodiments the deflectors 650 may also apply some pressure to the WAT tape 200 to aid in sealing the carton 200.

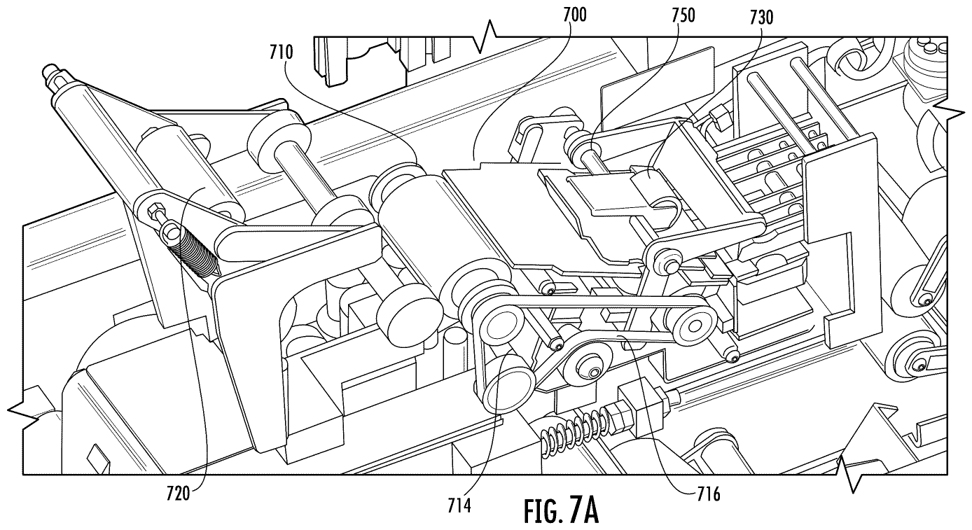

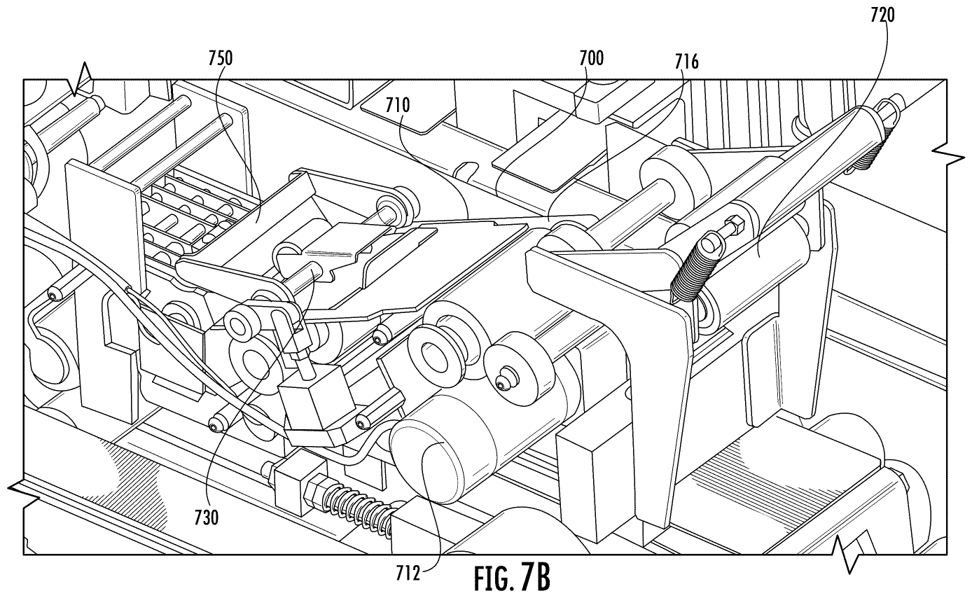

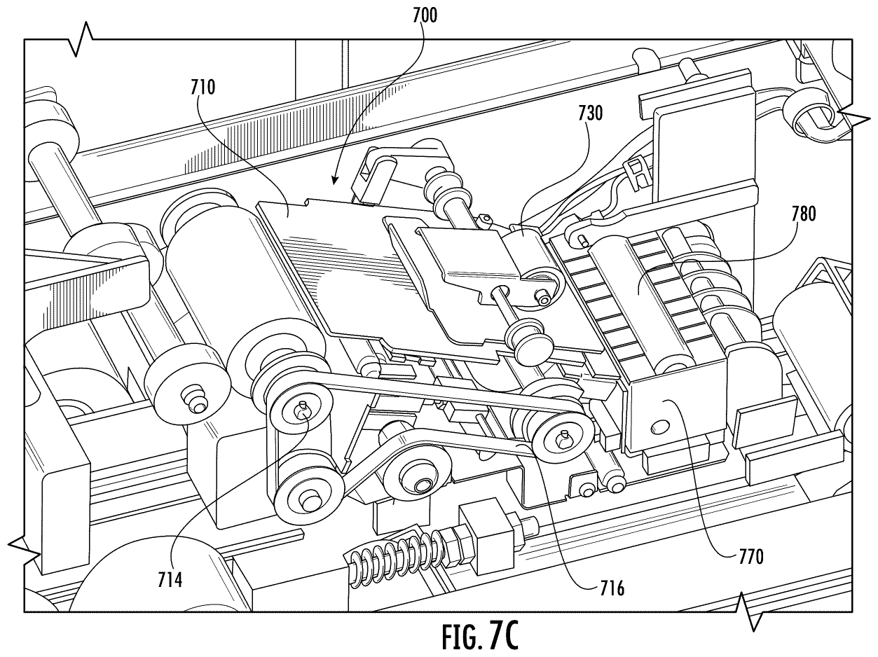

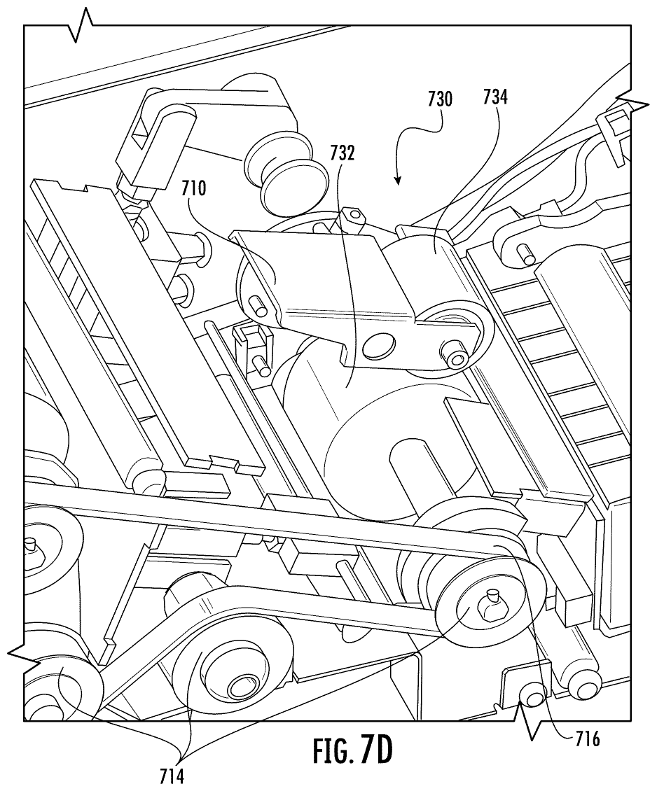

FIGS. 7A through 7D illustrate views of the top WAT tape head assembly 700. The top WAT tape head assembly 700 comprises a top tape feeder assembly 710 that is used to feed the tape through the top WAT tape head assembly 700 for activation of the WAT tape 200 and application to the carton 100. The top tape feeder assembly 710 may comprise a tape drive 712 (e.g., motor, or the like), a drive train 714 (e.g., drive rollers, pullies, gears, or the like), a flexible tape member 716 (e.g., belt, chain, rope, or the like), one or more guide rollers 720, a pinch roller assembly 730 (e.g., a driven roller 732, a pinch roller 734), or the like. The pinch roller assembly 730 may be used not only to feed the WAT tape 200 for the initial application to the carton 100, but to feed the WAT tape 200 throughout the application of the WAT tape 200 to the carton 100 in order to restrict (e.g., reduce, prevent, or the like) slippage of the WAT tape 200 during sealing of the carton 100. As will be described in further detail with respect to the controller 2010 of the carton sealing apparatus 1, the pinch roller assembly 730 may feed the tape at a speed that corresponds (e.g., the same or similar speeds) to the speed at which the carton 100 is being feed through the carton sealing apparatus 1. As will be described in further detail herein, feeding the tape throughout the sealing process aids in increasing the speed at which the carton 100 may be sealed using the WAT tape 200.

As further illustrated in FIGS. 7A through 7D, the top WAT tape head assembly 700 may further comprise a tape separator assembly 750 (e.g., a blade, blade support, blade support axle, actuator, or the like). The tape separator assembly 750 may be engaged once the proper length of WAT tape 200 has been dispensed.

FIG. 7C further illustrates the WAT tape head assembly 700, which will be described in further detail with respect to the water supply assembly 1000. The WAT tape head assembly 700 comprises a water pot 770, a water applicator 780 (e.g., illustrated as a roller 782, but could be a sponge, nozzle sprayer, or the like) that utilizes water from the water supply assembly 1000 to apply the water to the WAT tape 200 for activation of the adhesive layer on the WAT tape 200.

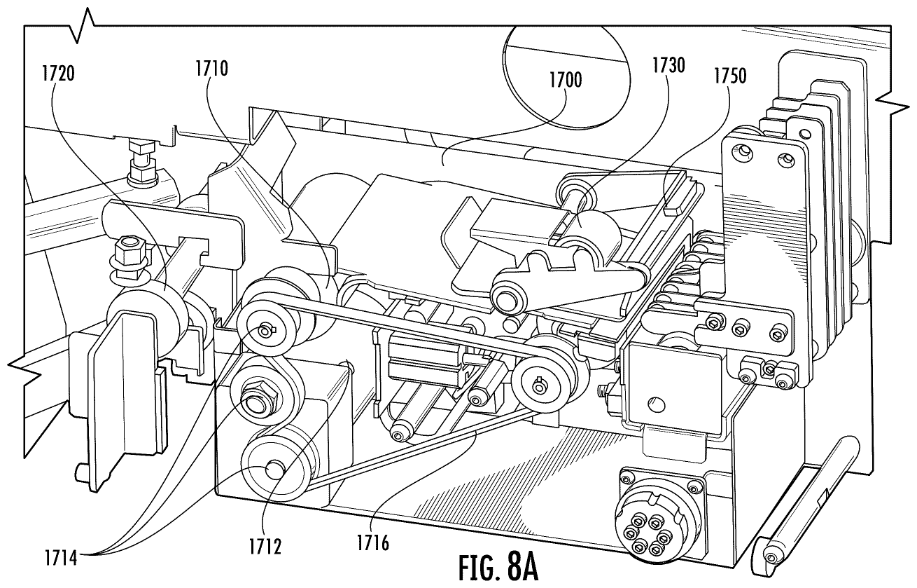

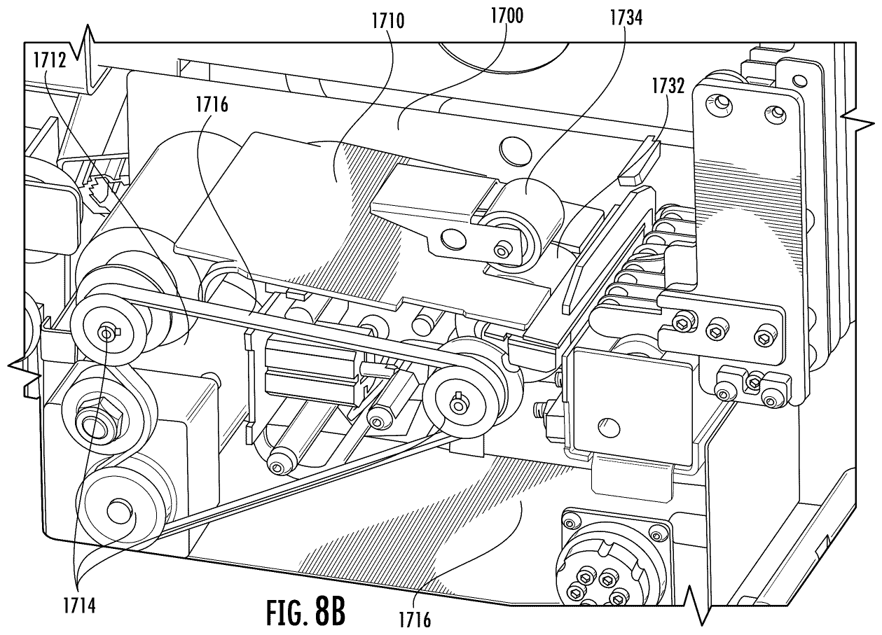

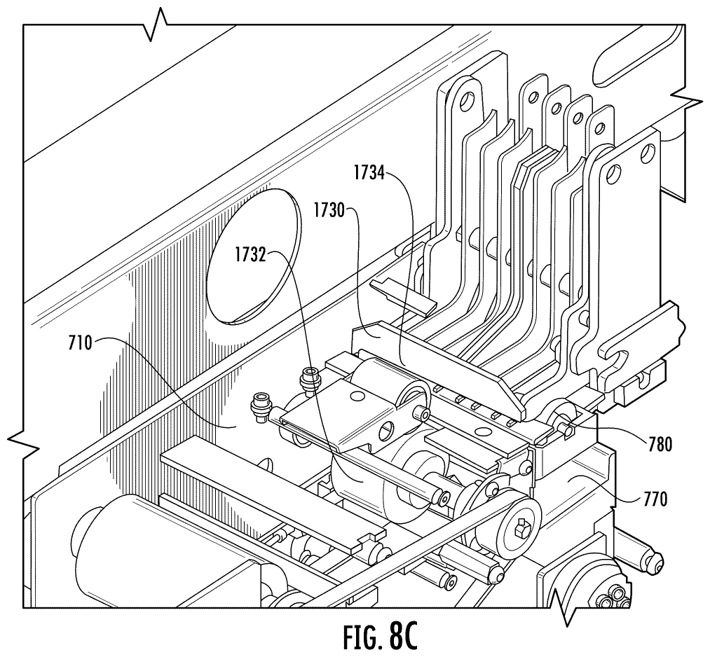

FIGS. 8A through 8C illustrates the bottom WAT tape head assembly 1700. The bottom WAT tape head assembly 1700, is the same as or similar to the top WAT tape head assembly 700, and comprises a bottom tape feeder assembly 1710 that is used to feed the WAT tape 100 through the bottom WAT tape head assembly 1700 for activation of the WAT tape 200 and application to the carton 100. The bottom tape feeder assembly 1710 may comprise a bottom tape drive 1712 (e.g., motor, or the like), a bottom drive train 1714 (e.g., driven rollers, pullies, gears, or the like), a bottom flexible tape member 1716 (e.g., belt, chain, rope, or the like), one or more bottom tape guide rollers 1720, a bottom pinch roller assembly 1730 (e.g., a driven roller 1732, a pinch roller 1734), or the like. The bottom pinch roller assembly 1730 may be used not only to feed the WAT tape 200 for the initial application to the carton 100, but to also feed the WAT tape 200 throughout the application of the WAT tape 200 to the carton 100 in order to restrict (e.g., reduce, prevent, or the like) slippage of the WAT tape 200 during sealing of the carton 100. As will be described in further detail with respect to the controller 2010 of the carton sealing apparatus 1, the bottom pinch roller assembly 1730 may feed the WAT tape 200 at the speeds that correspond (e.g., same or similar speeds) to the speed at which the carton 100 is being feed through the carton sealing apparatus 1. As will be described in further detail herein, feeding the WAT tape 200 throughout the sealing process aids in increasing the speed at which the carton 100 may be sealed using the WAT tape 200.

As further illustrated in FIGS. 8A through 8C, the bottom WAT tape head assembly 1700 may further comprise a bottom tape separator assembly 1750 (e.g., a blade, blade support, blade support axle, actuator, or the like). The bottom tape separator assembly 1750 may be engaged once the proper length of WAT tape 200 has been dispensed.

FIG. 8C further illustrates the bottom WAT tape head assembly 1700, which will be described in further detail with respect to the water supply assembly 1000. The WAT applicator assembly 1700 comprises a water pot 1770, a water applicator 1780 (e.g., illustrated as a roller, but could be a sponge, nozzle sprayer, or the like) that utilizes water from the water supply assembly 1000 to apply the water to the WAT tape 200 for activation of the adhesive layer on the WAT tape 200.

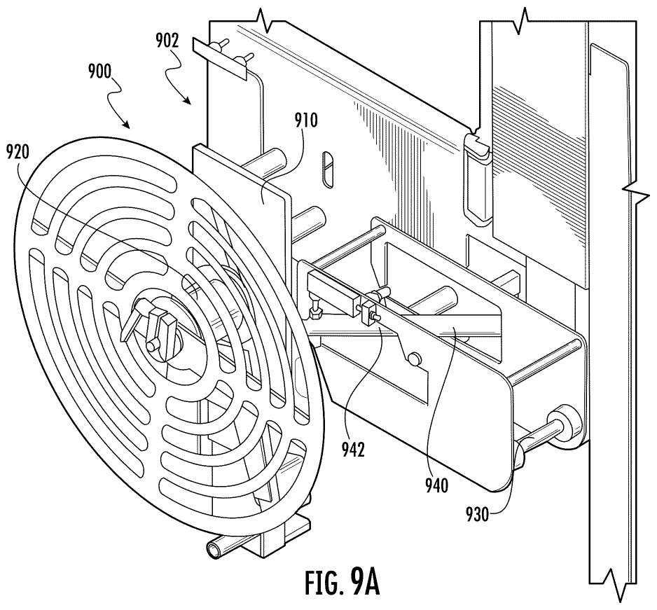

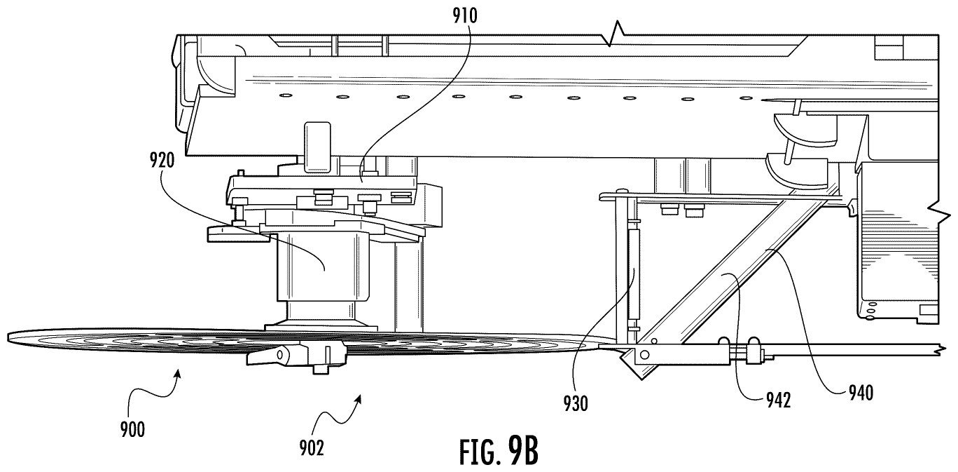

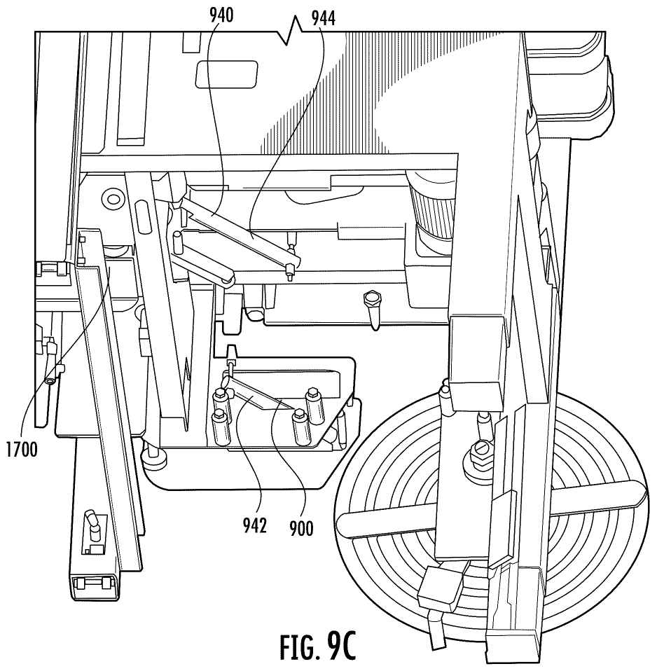

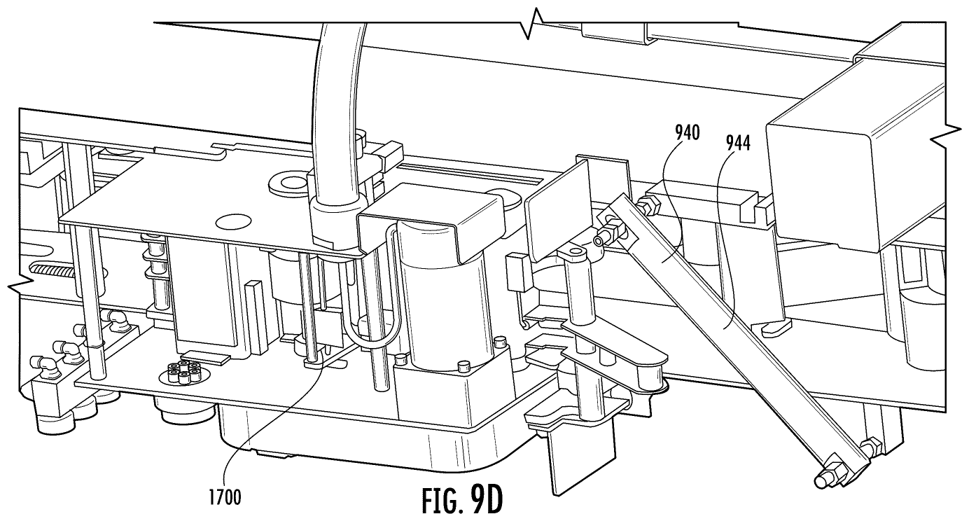

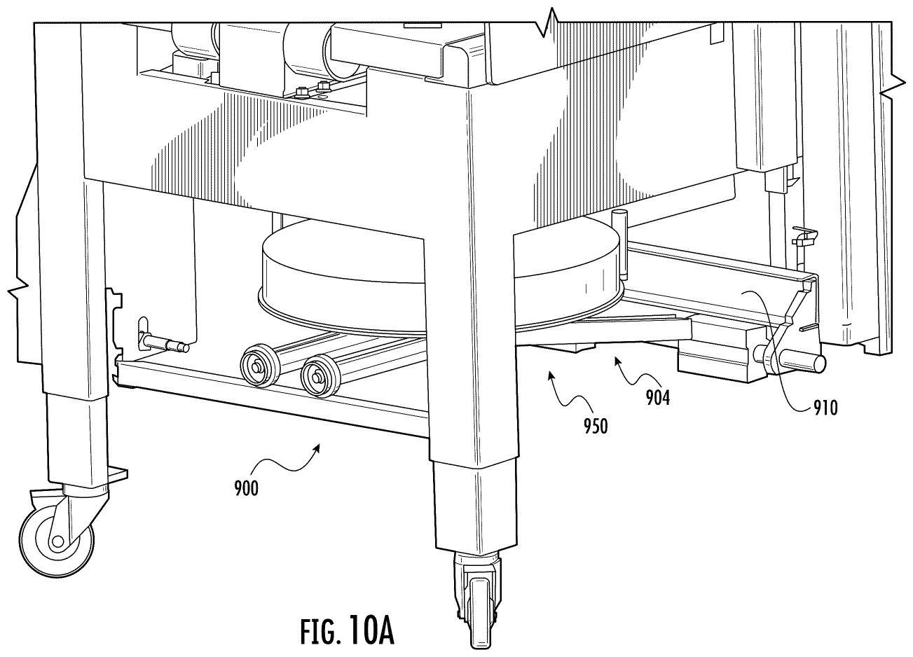

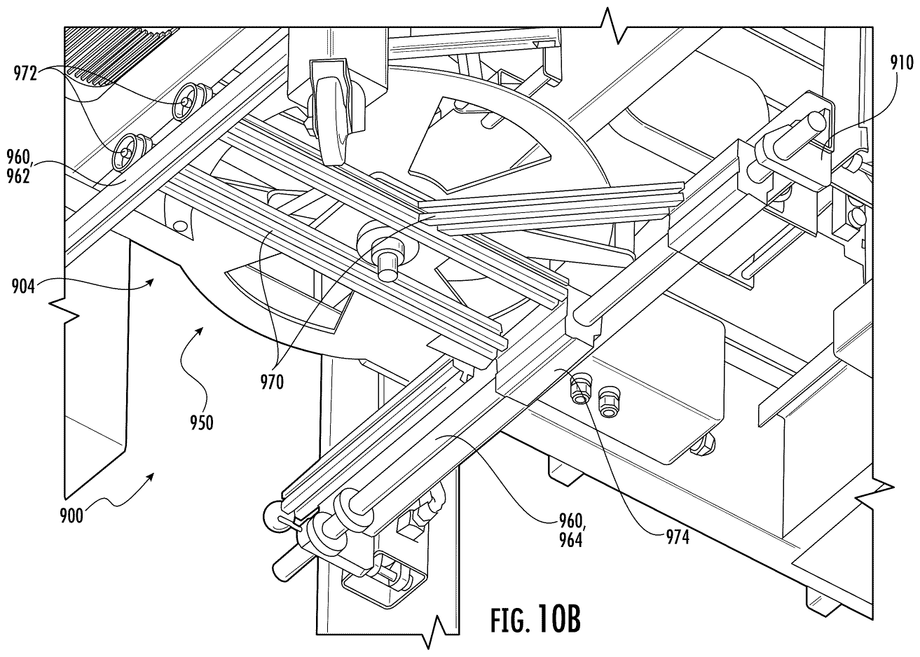

FIGS. 9A through 9D and FIGS. 10A and 10B illustrate embodiments of a bottom tape supply assembly 900, while the top tape supply assembly 800 is illustrated in FIGS. 1 and 2. It should be understood that the top tape supply assembly 800 may comprise a tape roll support assembly 810 (e.g., support members operatively coupled to the table 10 and/or support members 18 of the table 10). Moreover, the top tape supply assembly 800 may further comprise a top tape mandrel 820 which allows a roll of WAT tape 200 to rotate to dispense the WAT tape 200 from the tape roll. As illustrated in FIGS. 1 and 2, the top tape supply assembly 800 may be aligned in the same plane as the top WAT tape head assembly 700 to allow the WAT tape 200 to be fed directly in-line with the top WAT tape head assembly 700 and onto the carton 100.

Alternatively, unlike the top tape supply assembly 800, instead of being configured in-line with the bottom WAT tape head assembly 1700, the bottom tape supply assembly 900 may be offset with respect to the bottom WAT tape head assembly 1700, and thus, offset with the carton 100 being sealed by the bottom WAT tape 200. FIGS. 9A through 9D illustrate one embodiment of an offset bottom tape supply assembly 902, while FIGS. 10A through 10B illustrate one embodiment of angled bottom tape supply assembly 904. While two different bottom tape supply assemblies 900 are illustrated, it should be understood that the bottom tape supply assembly 900 may be both offset and angled with respect to the centerline of the carton sealing provided by the carton sealing apparatus 1. Regardless of the offset and/or angled configuration, the bottom tape supply assembly 900 may be configured to reduce the footprint of the carton sealing apparatus 1 versus traditional carton tape supplies, which like the top tape supply assembly 800, are located in-line with the carton sealing apparatus 1, which requires an extension of the exit side 14 of the table 10 of the carton sealing apparatus 1.

Returning to FIGS. 9A through 9D, the offset bottom tape supply assembly 902 may comprise a tape roll support assembly 910 (e.g., support members operatively coupled to the table 10 and/or support members 16, 18 of the table 12). Moreover, the bottom tape supply assembly 900 may further comprise a bottom tape mandrel 920 which allows a roll of WAT tape 200 to rotate to dispense the WAT tape 200 from the tape roll. The bottom tape supply assembly 902 may comprise a one or more guide rollers 930 and one or more turn members 940 (e.g., static turn bars, turn rollers, or the like), such as a first turn member 942 and a second turn member 944. That is, the first turn member 942 turns the WAT tape 200 from the tape supply roll towards the centerline of the carton sealing apparatus 1, and the second turn member 944 turns the WAT tape 200 at the centerline of the carton sealing apparatus 1 towards the bottom WAT tape head assembly 1700.

Returning to FIGS. 10A and 10B, the angled tape supply assembly 904 may also comprise a tape roll support assembly 910 (e.g., support members operatively coupled to the table 10 and/or support members 16, 18 of the table 10). The tape roll support assembly 910 may comprise an adjustable tape roll storage assembly 950 such that the tape roll may be located under the carton sealing apparatus 1. The tape roll storage assembly 950 may comprise one or more tape roll tracks 960 (e.g., track with a cavity 962, rod track 964, or the like), one or more tape roll carriages 970 having one or more carriage rollers 972 and/or one or more slides 974 (e.g., with bearings, rollers, or the like) operatively coupled to the one or more tape roll tracks 960. As such, the tape roll storage assembly 950 allows the tape roll to be stored under the table 10 and extended out from under the table 10 when the tape roll needs to be changed (e.g., through movement of the tape roll carriage 970 with respect to the one or more tape roll tracks 960). It should be understood that the angled bottom tape roll supply assembly 904 may store the tape roll horizontally with respect to the table 10 and/or carton sealing apparatus 1 components; however, it should be understood that the tape roll may be stored at any angle (e.g., 10, 15, 20, 25, 30, 35, 40, 45, or the like degrees) and still be stored under the table 10.

Like the offset bottom tape supply assembly 902, the angled bottom tape supply assembly 904 may comprise a top tape mandrel 920 which allows a roll of WAT tape 200 to rotate to dispense the WAT tape 200 from the roll. The bottom tape supply assembly 900 may comprise a one or more guide rollers 930 and one or more turn members 940 (e.g., static turn bars, turn rollers, or the like). In some embodiments, since the angled bottom tape supply assembly 904 is still located in-line with the center line of the carton sealing apparatus 1 (e.g., the bottom WAT tape head assembly 1700), only one turn member may be required to direct the WAT tape 200 from the tape supply roll towards the bottom WAT tape head assembly 1700. However, it should be understood that any number of bottom tape guide rollers 930 and/or turn members 940 may be utilized.

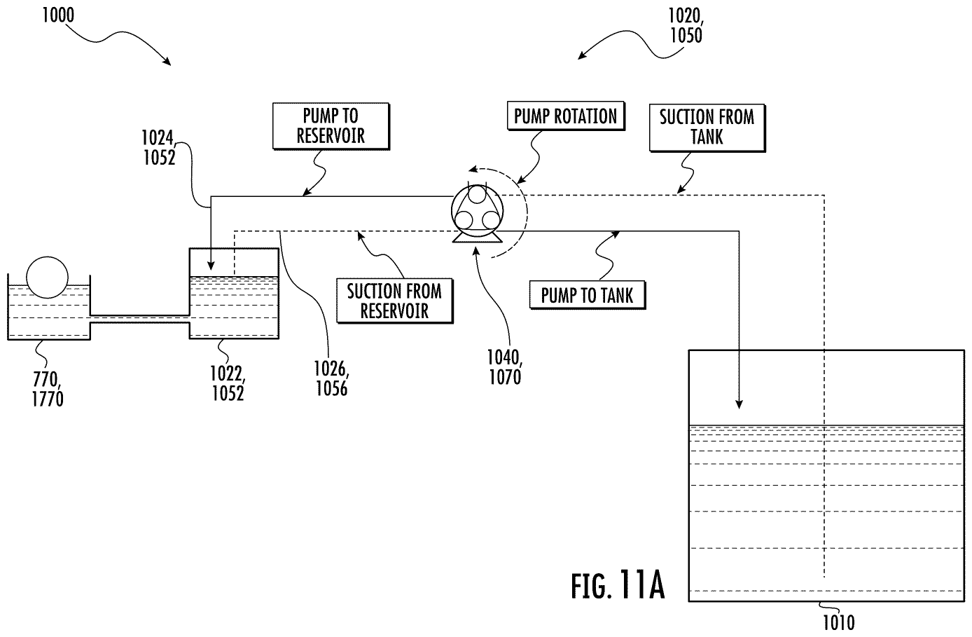

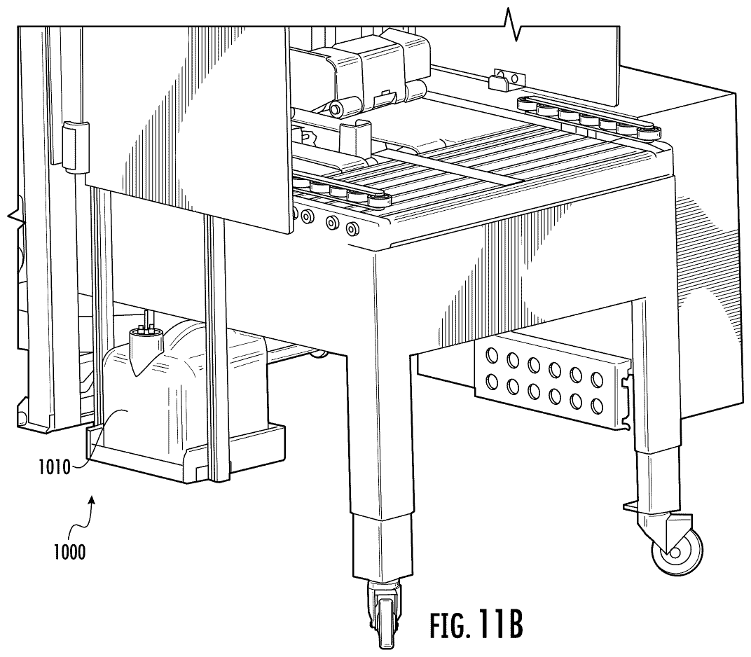

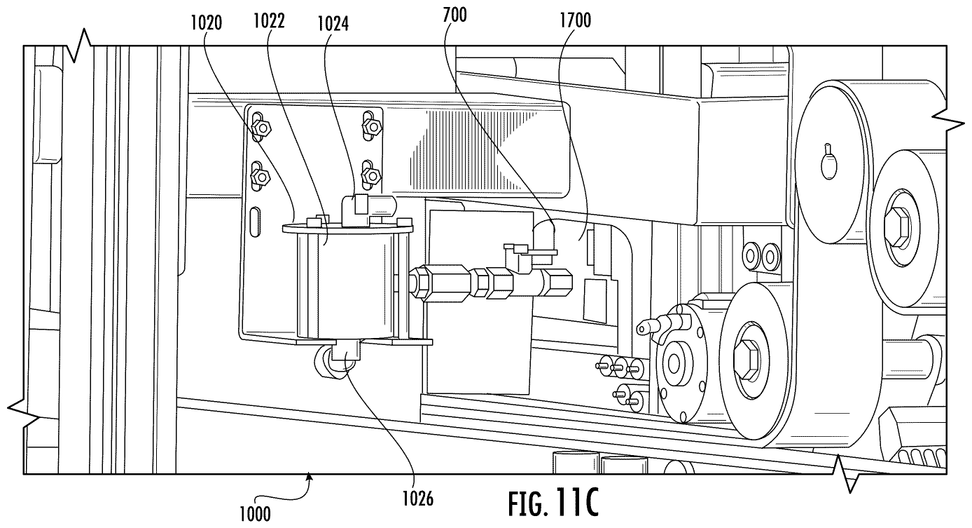

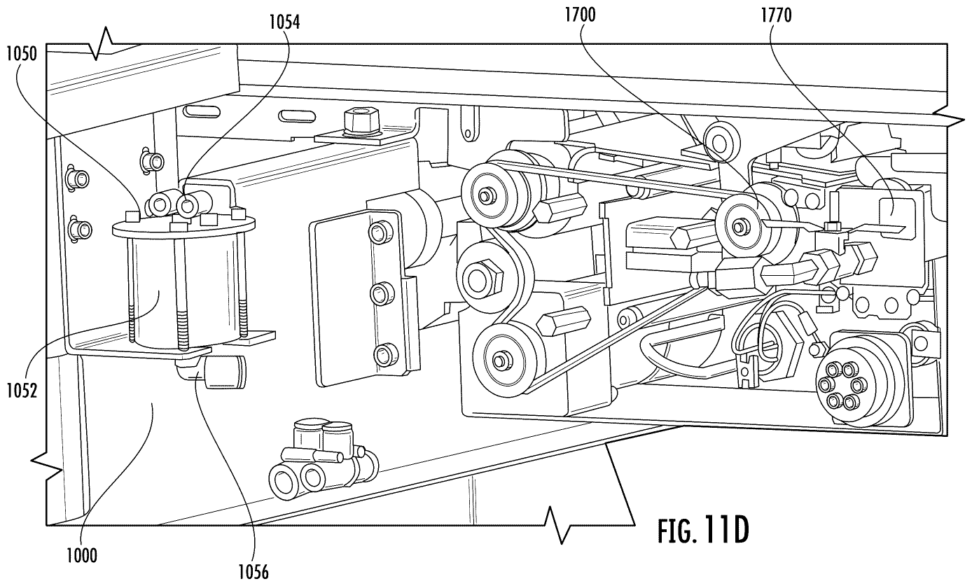

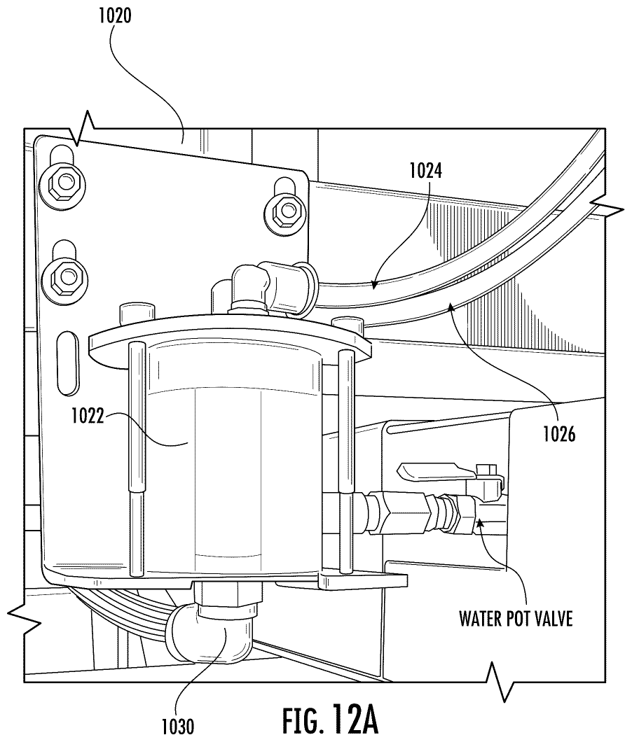

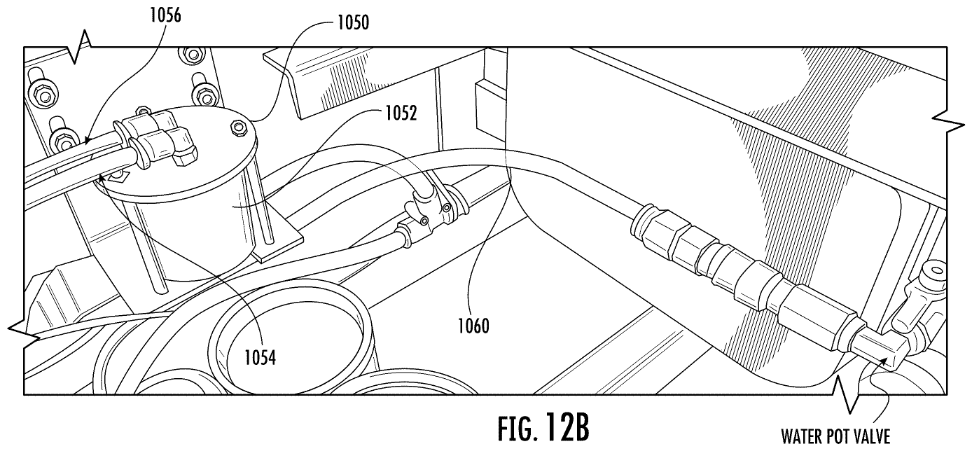

FIGS. 11A through 11D illustrate a water supply assembly 1000 that is used to deliver water to the top WAT tape head assembly 700 and the bottom WAT tape head assembly 1700. As illustrated in the schematic of FIG. 11A, the water supply assembly 1000 may utilize one or more centralized tanks 1010 that provide water to a top water supply assembly 1020 and a bottom water supply assembly 1050. The schematic of FIG. 11A may represent the top water supply assembly 1020 and/or the bottom water supply assembly 1050. The top water supply assembly 1020 comprises a top water reservoir 1022, one or more reservoir inlets 1024, one or more reservoir outlets 1026, and/or one or more pumps 1040 (e.g., one or more peristaltic pumps, or other pumps). The bottom water supply assembly 1050 comprises a bottom water reservoir 1052, one or more reservoir inlets 1054, one or more outlets 1056, and/or one or more pumps 1070 (e.g., one or more peristaltic pumps, or other pumps). Moreover, the reservoirs 1022, 1052 are coupled to the water pots 770, 1770 through one or more water pot conduits 1030, 1060. However, the water from the reservoirs 1022, 1052 may be delivered to the water pots 770, 1770 through other components (e.g., pumps, or the like).

In some embodiments, the water is pumped into the reservoir inlets 1024, 1054 and sucked out of the reservoir outlets 1026, 1056 at the same time (as will be described below). The level of water in the reservoirs 1022, 1052 is determined by the location (e.g., heights) of the reservoir outlets 1026, 1056, which will determine the water level in the water pots 770, 1770 through the connection made by the water pot conduits 1030, 1060 (e.g., the height of the water in the water pots 770, 1770 will equalize with the height of the water in the water reservoirs 1022, 1052). In some embodiments the reservoirs inlets 1024, 1054 are located higher than the reservoir outlets 1026, 1056 so that there is a visual indication of the water flowing into the reservoirs 1022, 1052 in order to determine that the water supply assembly 1000 is operating properly.

During operation, the one or more pumps 1040, 1060 suck water from the one or more centralized tanks 1010 (e.g., through a dip tube in the centralized tank, or the like) and pushes the water into the reservoirs 1022, 1052 through the reservoir inlets 1024, 1054, and thus, into the water pots 770, 1770 through the water pot conduits 1030, 1060. When the water level in the reservoirs 1022, 1052 is below the location of the ends of the reservoir outlets 1026, 1056, the reservoirs 1022, 1052 fill up until reaching the reservoir outlets 1026, 1056 (e.g., by first sucking air out of the reservoirs, then water when the water reaches the reservoir outlets 1026, 1056). At this time, water is sucked from the reservoirs 1022, 1052 and retuned back to the one or more centralized tanks 1010. The one or more pumps 1040, 1070 run at rates faster than the rate at which water is being applied to the WAT tape 200. Consequently, the water level in the reservoirs 1022, 1052, and thus, the water pots 770, 1770 stays constant (e.g., so long as there is water in the one or more centralized tanks 1010).

It should be understood that multiple pumps may be used for pumping water into and out of the reservoirs 1022, 1052. In other embodiments a single pump may be used that has two peristaltic stations. Each peristaltic station may have two lines pumping water away from the pump and two lines sucking water into the pump.

Maintaining the level in the water pots 770, 1770, and thus the application of a consistent (e.g., same or similar) amount of water to the WAT tape 200 (e.g., at the top and bottom) improves the application of the WAT tape 200 to the carton 100. In traditional systems that deliver water directly to the water pots and/or through the use of independent water bottles (e.g., that have a reduced water level as the water is used) hysteresis issues may occur. That is, more water is applied to the WAT tape 200 when the water bottles are full and/or less water is applied to the WAT tape 200 the lower the levels of the water in the water bottles. As such, the optimized water application to the WAT tape 200 only occurs at particular time. Unlike the traditional systems, the water levels in the reservoirs 1022, 1052 are maintained at an optimized level in order to apply the optimized level of water to the water pots 770, 1770 for optimized application to the WAT tape 200 during sealing. Furthermore, utilizing one or more water supply tanks 1010 allows for the use of larger tape rolls, such that the tanks 1010 and/or the tape rolls do not need to be switched out as often as when compared to the use of the one or more bottles (e.g., due to space restrictions the one or more bottles are smaller than the one or more tanks). Moreover, the supply tank 1010 may be switched out while the carton sealing apparatus 1 is operating. That is, the one or more pumps 1030, 1060 may take in some air bubbles during the swap, but they would be purged when the supply lines are connected to the new replacement supply tank 1010.

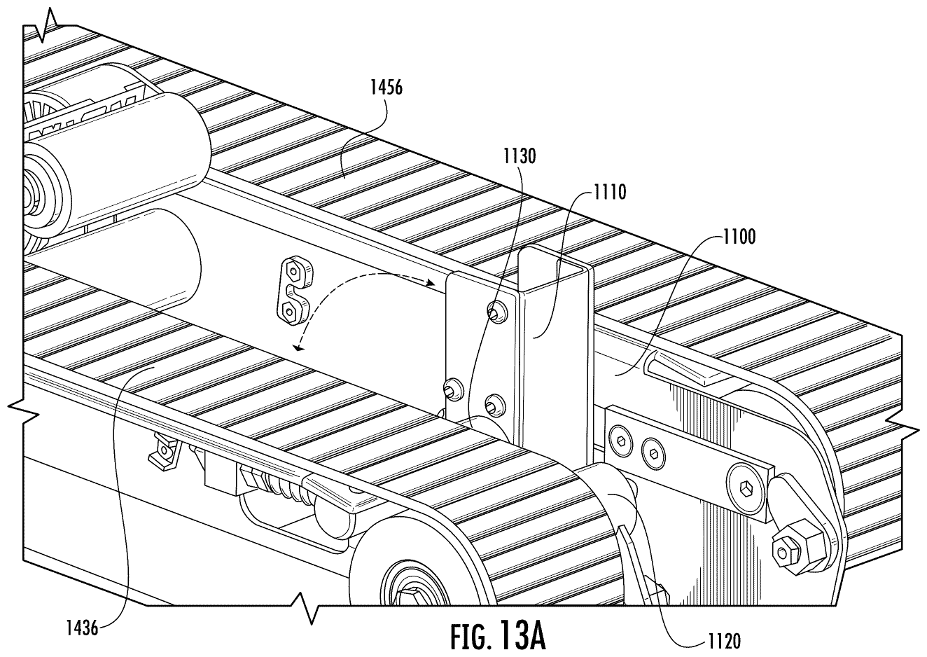

FIGS. 13A and 13B illustrate a carton gate assembly 1100 that is utilized to control the timing of supplying the cartons 100 to the WAT carton sealing apparatus 1 for sealing. The carton sealing apparatus 1 may comprise a gate member 1110, a gate drive 1120 (e.g., motor, actuator, drive, or the like), a pivot connector 1130, or the like. When a carton 100 is located in the entry side 12 in the correct position (e.g., adjacent the gate member 1110 and centered by the centering assembly 20) and the carton sealing apparatus 1 is ready to seal the carton 100 (e.g., the previous carton has been sealed and/or the top carton sealing assembly 300 is moved into the correct position based on the next carton height), the gate drive 1120 rotates the gate member 1110 backward into a retracted position below the bottom flexible members 1436, 1456 of the a bottom carton sealing assembly 1300.

The carton gate assembly 1100 restricts a carton 100 from entering the carton sealing apparatus 1 early, which could result in poor or improper taping (e.g., misaligned taping, jamming, bunching, or the like). Moreover, traditional gates 1110 use a reciprocating knife action with vertical movement or a roller, both which can damage the carton 100 that is being sealed (e.g., the flaps of the carton). The rotating action of the carton gate assembly 1100 restricts the damage that might occur to the carton 100. Furthermore, if the carton 100 is not in the correct position or the carton sealing apparatus 1 has not completed the sealing of the previous carton 100, the top carton sealing apparatus 300 may move vertically a short distance to restrict the top flexible members 436, 456 from prematurely contacting the carton 100 before the gate member 1110 is retracted and the carton sealing apparatus 1 is ready for sealing the carton 100. In particular embodiments, when pneumatic cylinders are used, the vertical movement may be controlled through the use of a puff of air delivered by the pneumatic cylinders to move the top carton sealing apparatus 300 slightly vertically upwards.

FIG. 14 illustrates an example embodiment of a carton 100 sealed with the WAT tape 200 for sealing both the top of the carton 100 and the bottom of the carton 100. As illustrated in FIG. 14, the carton 100 may comprise a top portion 102 with a plurality of flaps 110, such as first and second upper inner flaps (not illustrated) and first and second upper outer flaps 112, 114. Moreover, the carton 100 includes a bottom portion 104, which may also have first and second lower inner flaps (not illustrated) and first and second lower outer flaps 116, 118. The carton 100 may further include a leading side 105, a trailing side 106, and first and second flanking sides 107, 108 extending between the leading side 105 and the trailing side 106. While the leading side 105 and trailing side 106 are illustrated as being shorter than the first flanking side 107 and second flanking side 108, it should be understood that the leading side 105 and trailing side 106 may be longer than the first flanking side 107 and the second flanking side 108.

The WAT tape 200 may extend from the leading side 105, around the shoulder between the leading side 105 and the top 102 of the carton 100, along the top 102 of the carton over the first upper outer flap 112 and the second upper outer flap 114, around the shoulder between the top 102 and trailing side 106 of the carton 100, and down the trailing side 106 of the carton 100. The WAT tape 200 may also be located along the bottom 104 of the carton, such as over the two lower flaps 116, 118, around the shoulders between the bottom 104 of the carton and the leading and trailing sides 105, 106 of the carton 100 in the same or similar way as described with respect to the top 102 of the carton 100.

FIGS. 15A through 15D illustrate embodiments of the WAT tape 200 that may be utilized to seal the carton 100. For example, the WAT tape 200 may be provided in the form of a tape roll 220 wound onto a core 222. Referring to FIGS. 15A and 15B, from top to bottom relative to the page, the WAT tape 200 may include an outermost layer 224 (e.g., a paper layer, or other like material layer), and an adhesive layer 226 (e.g., WAT adhesive layer, or the like). The outermost layer 224 (otherwise referred to as a substrate) has a first major (top) surface 232 and a second major (bottom) surface 234 adjacent to the adhesive layer 226. Adhesive layer 226 can be continuous or discontinuous. The outermost layer 224 has essentially an unlimited length, and has a width, and the second major (bottom) surface 234 of the outermost layer 224 defines a thickness. In one example, the thickness of the outermost layer 224 is between 1.85 and 3.7 mil.

Referring to FIGS. 15C and 15D, from top to bottom relative to the page, the WAT tape 200 includes an outermost layer 224 (e.g., paper layer, other type of material substrate), a reinforcement 228 and laminating adhesive, an innermost layer 229 (e.g., paper layer, other type of material substrate), and an adhesive layer 226 (e.g., WAT adhesive layer, or the like). Adhesive layer 226 can be continuous or discontinuous. The outermost layer 224 (otherwise referred to as an outer substrate) has a first major (top) surface 232 distal from the innermost layer 229 (otherwise referred to as an inner substrate), and a second major (bottom) surface 234 proximal to the reinforcement 228. The outmost layer 224 has essentially an unlimited length, and has a width, and the second major (bottom) surface 234 of the outermost paper layer 224 defines a thickness. In one example, the thickness of the outermost layer 224 is between 1.85 and 3.7 mil.

Reinforcement 228 and laminating adhesive, in one example, are introduced between the outermost layer 224 and innermost layer 229. Reinforcement 228 may be string, fibers, ceramic, fiberglass, carbon, polyester, other types of reinforcements. In one example, the reinforcement is ceramic fiber, fiberglass, or carbon fiber. In one example, the reinforcement is water soluble polymer, for example, poly vinyl alcohol, polylactate, or copolymers thereof. The reinforcement layer 228 may form one or more coffered areas having any size or shape (e.g., diamond, trapezoidal, triangular, oval, circular, semi-circular, any polygonal, uniform, non-uniform, or the like shape). In one example, reinforcement layer 228 is positioned between a backing (e.g., outermost layer 224) and an adhesive layer 226.

Various means of introducing the laminating adhesive between the outermost layer 224 and innermost layer 229 can be used, such as blade coating, solvent dispensing, roll coating, extrusion, extrusion lamination, or the like. In one example, the laminating adhesive is a cellulose-based adhesive. In one example, the laminating adhesive is a starch-based adhesive. In one example, the laminating adhesive is a starch-based adhesive and is present at a thickness of about 0.1 mil to about 2 mil. In another example, the starch-based laminating adhesive is present at a thickness of about 0.5 mil (12.7 micron) to about 1.3 mil (32.5 micron). The to-be laminated surfaces of the corresponding paper layers 229, 224 and/or the reinforcement 228 can be pretreated using such methods as corona or flame treatment to ensure or enhance adhesion.

In some embodiment, the laminating adhesive is contiguous to the innermost layer 229, the outermost layer 224, and/or the reinforcement 228. In one example, the laminating adhesive is starch-based. In one example, the starch-based laminating adhesive is semi-contiguous to the innermost paper layer 229, the outermost layer 224, and/or the reinforcement 228. In one example, the starch-based laminating adhesive at least partially fills all or some voids or gaps in the reinforcement 228.

In some embodiments, after lamination, the reinforcement 228 is adjacent to the second major (bottom) surface of the outermost layer 224. In one example, after lamination, the reinforcement 228 is directly adjacent to the second major (bottom) surface of the outermost layer 224, whereas there are no intervening layers or material therebetween.

In some embodiments, after lamination, the reinforcement 228 is adjacent to the first major (top) surface 232 of the innermost layer 229. In other embodiments, after lamination, the reinforcement 228 is directly adjacent to the first major (top) surface 232 of the innermost layer 229, whereas there are no intervening layers or material therebetween.

In some embodiments, after lamination, the reinforcement 228 is directly adjacent to the second major (bottom) 234 surface of the outermost layer 224 and directly adjacent to the first major (top) surface 232 of the innermost layer 229, whereas there are no intervening layers or material therebetween.

Innermost and outermost layers 229, 224, respectively, may be the same or different composition, thickness, color, or the like. In some embodiments, the innermost and outermost layers 229, 224, respectively, are any type of paper including, but not limited to, crepe paper, non-crepe paper, or release paper. In one example, kraft paper (e.g., bleached or natural kraft paper) is used as the innermost and outermost paper layers 229, 224, respectively. In some embodiments, the innermost and outermost layers 229, 224, respectively, is a bleached or unbleached kraft paper. In one example, the innermost and outermost layers 229, 224, respectively, are creped NBSK (Northern Bleached Softwood kraft) paper web.

In some embodiments, the WAT tape 200 may include a single layer 224 (top) to which the adhesive layer 226 is attached. One or more layers of the adhesive layer 226 can be applied to a surface of a substrate.

While the present invention is particularly used with WAT tape 200, it should be understood that at least some of the assemblies of the carton sealing apparatus 1 of the present disclosure may be used for a pressure sensitive adhesive (PSA) tape, such as elastomeric-based PSA. Typical varieties of PSAs are derived from natural rubber, synthetic rubber, acrylic, silicone, starch, and modifications and combinations thereof. The following adhesive compounds, solutions, or emulsions may be used, either alone or in combination, without departing from the scope of this disclosure. Rubber based adhesives such as, but not limited to, natural rubber, synthetic polyisoprene, styrene-isoprene-styrene block copolymer (SIS), styrene-butadiene-styrene block copolymer (SBS), styrene-ethylene-butylene-styrene block co-polymer (SEBS), styrene-ethylene-propylene-styrene block copolymer (SEPS), styrene butadiene rubber, nitrile rubber, neoprene rubber, butyral and butyl rubber, atactic polypropylene, polyisobutylene, polysulfide rubber, silicone rubber, natural latex rubber, and synthetic latex rubber. Resin-based adhesives such as, but not limited to, polyvinyl acetate, polyvinyl butyral, polyvinyl chloride, acrylic, ethylene vinyl acetate, polyethylene-based, polyolefin based, nylon-based, phenol-based (including formaldehyde-based), urea-based (including formaldehyde-based), epoxy resin, polyurethane-based, rosin-based (including rosin esters), polyterpene-based, polyester, petroleum based, and low molecular weight based adhesives. Inorganic adhesives such as, but not limited to, silicate adhesive and wax adhesives such as, but not limited to, paraffin, natural wax, and bee's wax. Such PSA's can be solvent-cast, aqueous, solventless, or molten film or as a coating layer using either extrusion, any manner of roll, knife, rod, or blade coating, curtain coating or any suitable method. The adhesive layer can be cross-linked by means of heat or radiation.

In the embodiments in which the WAT tape 200 is utilized, the water-activated adhesive may comprise a cellulose-based adhesive. In one example, the water-activated adhesive may comprise a starch-based adhesive. In one example, the water-activated adhesive may comprise a starch-based adhesive grafted with a monomer for example, an acrylic acid monomer, acrylamide monomer, acrylonitrile monomer, or combinations thereof. In one example, the water-activated adhesive may comprise a starch-based adhesive blended with polyacrylic acid, polyacrylamide and/or polyacrylonitrile. In one example, the water-activated adhesive may comprise a starch-based adhesive grafted with a monomer, for example, an acrylic acid monomer, acrylamide monomer and/or acrylonitrile monomer and that is blended with polyacrylic acid, polyacrylamide, polyacrylonitrile or combinations or copolymers thereof. The polyacrylic acid, polyacrylamide, polyacrylonitrile or combinations or copolymers thereof can be the result of self-or co-polymerization during grafting of the starch, or these polymers can be added or mixed subsequently to grafting of a monomer or polymer, and the additional polymers can be the same or different than that of the grafted monomer or polymer. The grafted starch-based adhesive can be produced in batches or continuously. Two or more of the batches of the grafted starch-based adhesive can be blended or mixed to provide a requisite adhesive functionality.

In one example, the starch-based adhesive grafted with an acrylic acid and/or acrylamide monomer further comprises a base, for example, ammonium hydroxide and/or a metal hydroxide (MOH), such as sodium hydroxide or potassium hydroxide. Moreover, in one example, the water-activated adhesive further comprises ammonium persulfate (APS). Finally, in one example, the water activated adhesive further comprises water. The mixture may be heated until an exotherm begins to polymerize the acrylic acid and/or the acrylamide. Thereafter, heating is ceased and the exotherm is allowed to reach its maximum. As such, the adhesive is able to be coated onto the substrate.

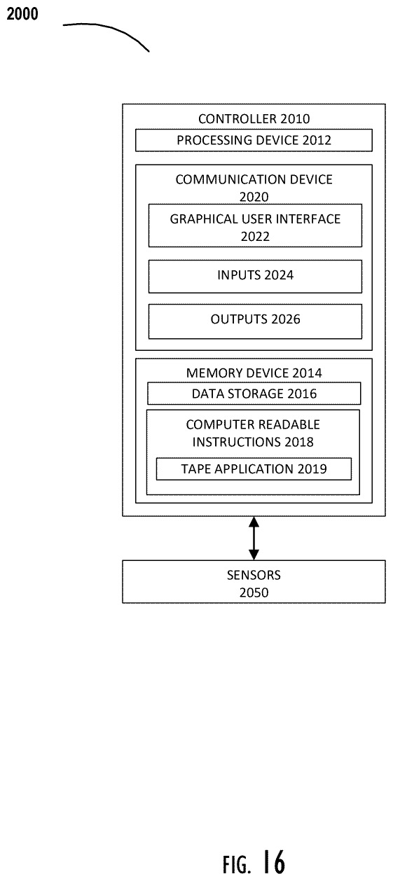

As previously discussed herein, the operation of the carton sealing apparatus 1 may be controlled through the use of a networked system 2000 with a controller 2010 (e.g., a programable controller), which may communicate with one or more sensors 2050 of the carton sealing apparatus and/or other systems within a facility, as illustrated in FIG. 16. As such, the controller 2010 may be operatively coupled, via a network, to one or more sensors 2050, one or more user computer systems (e.g., of employees within the facility, or the like), one or more product systems (e.g., providing the products and/or cartons to the apparatuses), and/or one or more other systems. In this way, the controller 2010 may operate the carton sealing apparatus 1 based on information received from one or more sensors 2050, one or more other components (e.g., motors, mechanical triggers, or the like), and/or one or more other systems (e.g., for determining a carton type, a product for a carton being provided, or the like for carton sealing). As such, a communication device 2020 on the carton sealing apparatus 1 may receive instructions from one or more sensors 2050, from a user manually providing input at the carton sealing apparatus 1, and/or from a user computer system (e.g., phone, desktop, remote, or the like). For example, a communication device 2020 may receive instructions from a user directly through an interface, such a graphical user interface 2022 (e.g., screen, touchscreen, or the like) and/or other inputs 2024 (e.g., buttons, or the like).

As such, when communicating over a network, the network may be a global area network (GAN), such as the Internet, a wide area network (WAN), a local area network (LAN), or any other type of network or combination of networks. The network may provide for wireline, wireless, or a combination of wireline and wireless communication between systems, services, components, and/or devices on the network.

Regardless of the configuration, the controller 2010 may comprise and/or be operatively coupled to the one or more communication devices 2020 (e.g., interfaces, such as one or more graphical user interfaces 2022, inputs 2024, outputs 2026), one or more processing devices 2012, and one or more memory devices 2016. The one or more processing devices 2012 are operatively coupled to the one or more communication devices 2020, and the one or more memory devices 2014. As used herein, the term “processing device” generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing devices 2012 according to their respective capabilities. The one or more processing devices 2012 may include functionality to operate one or more software programs based on computer-readable instructions 2018 thereof, which may be stored in the one or more memory devices 2014. It should be understood that the devices described herein may also be described as components, or generally as a processor, memory, or communicators, or the like.

The controller 2010, such as the one or more communication devices 2020, may be operatively coupled to the one or more sensors 2050 (e.g., safety sensors, supply sensors, location/position sensors, carton sensors, liquid level sensors, tape supply sensors, or the like) located within the carton sealing apparatus 1 and/or the assemblies thereof. As previously discussed herein, the one or more sensors 2050 may be used to determine when to activate the gate assembly, activate the tape supplies, the cut the WAT tape 200, provide notifications (e.g., alarms, messages, or the like) for low tape supply, low water supply, and/or other carton sealing apparatus 1 operational information.

The one or more processing devices 2012 may use the one or more communication devices 2020 to communicate with the network and other devices on the network, such as, but not limited to, the devices of the one or more user computer systems, the one or more product or carton supply systems, and/or the other systems. As such, the one or more communication devices 2020 generally comprise a wireless transceiver, modem, server, electrical connection, electrical circuit, or other device for communicating with other devices on the network. The one or more communication devices 2020 may further include an interface that accepts one or more network interface cards, ports for connection of network components, Universal Serial Bus (USB) connectors, or the like. Moreover, the one or more communication devices 2020 may include a keypad, keyboard, touchscreen, touchpad, microphone, mouse, joystick, other pointer component, button, soft key, and/or other input/output component(s) for communicating with the users. In some embodiments, as described herein, the one or more communication components may comprise a user interface, such as a graphical user interface 2022 that acts as an input 2024 and/or output 2026 that allows a user to control and/or monitor the operation of the carton sealing apparatus 1 described herein.

The controller 2010 may comprise computer-readable instructions stored in the one or more memory devices 2014, which in some embodiments includes the computer-readable instructions used to operate the carton sealing apparatus 1 and/or the assemblies thereof, such as for moving the carton 100, dispensing the WAT tape 200, or the like. In some embodiments, the one or more memory devices 2014 include one or more data stores 2016 for storing data related to the carton sealing apparatus 1 including, but not limited to, data created, accessed, and/or used to operate the carton sealing apparatus 1, as described herein.

As will be appreciated by one of skill in the art in view of this disclosure, embodiments of the disclosure may be embodied as an apparatus, a system, computer program product, and/or other device, a method, or a combination of the foregoing. Accordingly, embodiments of the disclosure may take the form of an entirely hardware embodiment, an entirely software embodiment (including firmware, resident software, micro-code, or the like), or an embodiment combining software and hardware aspects that may generally be referred to herein as a “system.” Furthermore, embodiments of the disclosure may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the disclosure may be written in an object oriented, scripted or unscripted programming language such as Java, Pearl, Python, Smalltalk, C++ or the like. However, the computer program code/computer-readable instructions for carrying out operations of the disclosure may also be written in conventional procedural programming languages, such as the “C” programming language or similar programming languages.

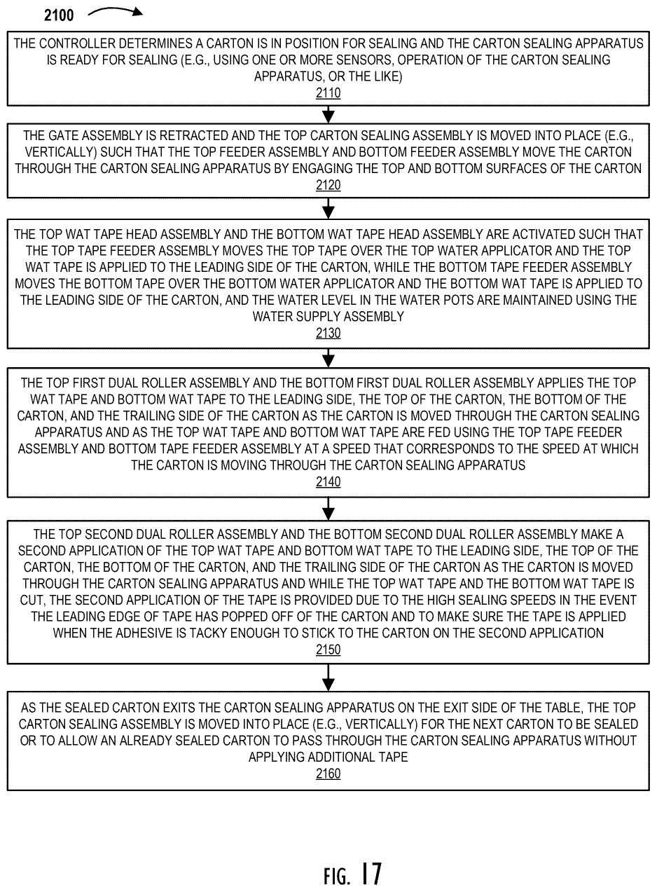

FIG. 17 provides a process flow 2100 for sealing a carton 100 using a carton sealing assembly 1. As illustrated in block 2110 of FIG. 17, the controller 2010 determines a carton 100 is in a position for sealing the carton 100 and the carton sealing apparatus 1 is ready for sealing (e.g., the previous carton has been sealed, exited the exit side 14 of the carton sealing apparatus 1, or the like). As previously described herein, the carton 100 being located in the correct position and/or the carton sealing apparatus 1 being ready to seal the next carton may be determined through the controller 2010 receiving information from one or more sensors 2050 and/or from the operation (or lack of operation) of the components within the carton sealing apparatus 1 (e.g., motors are off, or the like). As previously described herein, if the carton sealing apparatus 1 is not ready to seal the next carton the top carton sealing assembly 300 may be moved slightly upward to restrict damage that the top feeder assembly 400 may cause (e.g., the moving flexible members) to the carton 100 until the carton 100 is ready for sealing.

FIG. 17 further illustrates in block 2120 that when the carton sealing apparatus 1 is ready for sealing, the gate assembly 1100 is retracted (e.g., the gate member 1110 is rotated) and the top carton sealing assembly 300 is moved (e.g., vertically up or down) into place such that the top feeder assembly 400 and bottom feeder assembly 1400 move the carton 100 through the carton sealing apparatus 1 by engaging the top and/or bottom surfaces of the carton 100.

Block 2130 of FIG. 17 further illustrates that the top WAT tape head assembly 700 and the bottom WAT tape head assembly 1700 are activated such that the top tape feeder 710 assembly moves the top WAT tape 200 over the top water applicator 780 and the top WAT tape 200 is applied to the leading side of the carton 100. Moreover, the bottom tape feeder assembly 1700 moves the bottom WAT tape 200 over the bottom water applicator 1780 and the bottom WAT tape 200 is applied to the leading side of the carton 100. Moreover, as the water is being applied to the WAT tape 200 the water level in the water pots 770, 1770 are maintained using the water supply assembly 1000.

FIG. 17 further illustrates in block 2140 that the top first dual roller assembly 510 and the bottom first dual roller assembly 1510 applies the top WAT tape and bottom WAT tape to the leading side, the top of the carton, the bottom of the carton, and the trailing side of the carton 100 as the carton 100 is moved through the carton sealing apparatus 1. The top WAT tape 200 and the bottom WAT tape 200 are both fed using the top tape feeder assembly 710 and bottom tape feeder assembly 1710, respectively, at a speed that corresponds (e.g., is similar to, or the same as) the speed at which the carton 100 is moving through the carton sealing apparatus 1.

Block 2150 of FIG. 17 further illustrates that the top second dual roller assembly 540 and the bottom second dual roller assembly 1540 make a second application of the top WAT tape 200 and the bottom WAT tape 200 to the leading side, the top of the carton, the bottom of the carton, and the trailing side of the carton as the carton is moved through the carton sealing apparatus 1 and as the WAT tape 200 is separated (e.g., cut). The second application of the top WAT tape 200 and bottom WAT tape 200 is provided due to the high sealing speeds in the event the leading edge of the tape has popped oof of the carton and make sure the tape is applied when the adhesive is tacky enough to stick to the carton 100 on the second application

Block 2160 of FIG. 17 further illustrates that as the sealed carton 100 exits the carton sealing apparatus 1 at the exit side 14 of the carton sealing apparatus 1, the top carton sealing assembly 300 is moved into place (e.g., vertically) for sealing the next carton 100 (e.g., depending on the next carton height) to be sealed or to allow an already sealed carton 100 to pass through the carton sealing apparatus 1 without applying additional tape. That is, if a carton 100 has already been sealed and/or is already packed in a box that does not require sealing tape, the machine, through manual indication by a user or automatically through the use of a sensor, adjusts the height of the top carton sealing assembly 300 so that the already sealed carton 100 can travel downstream for further processing (e.g., labeling, scanning, shipping, or the like).

As generally described herein, the present invention and/or the one or more assemblies described herein, alone or in combination, provides improvements over traditional carton sealing apparatuses. In particular, the carton sealing apparatus 1 of the present disclosure is able to seal cartons 100 as much higher speeds, such as sealing cartons 100 as speeds of greater than, 100, 105, 110, 115, 120, 125, 130, 135, 140, 145, 150, 155, 160, 165, 170, 180, 190, 200, 210, 220, 230, 240, 250, or the like feet per minute (or range between, overlap, or fall outside of any of these values). As such, depending on the size of the cartons 100 being sealed, the carton sealing apparatus 1 of the present disclosure may be able to seal 15, 16, 17, 18, 19, 20, 21, 22, 23, 24, 25, or the like cartons per minute (or range between, overlap, or fall outside of any of these values). It should be understood that traditional carton sealing apparatuses may only seal cartons at speeds of around 80 ft/min, and thus, seal approximately 8 to 12 cartons per minute (when comparing the same sized cartons 100 processed by the carton sealing apparatus 1 of the present disclosure).

Specifically, as previously discussed herein, feeding the cartons 100 through the use of contact with the top and bottom of the carton 100 allows for faster feeding when compared to feeding the cartons 100 through the use of sidebelt feeding mechanisms. That is, traditional systems need to adjust both the side feeding mechanisms and a top carton sealing apparatus in order to adjust for both the changes in height and changes in width of different cartons 100. In the present disclosure, the carton sealing apparatus 1 only needs to adjust the top carton sealing assembly 300 to adjust for the height of the carton 100, which reduces the amount of time required to set up the carton sealing apparatus 1 for sealing different sized cartons 100 consecutively.

Furthermore, the use of the top second dual roller assembly 540 and the bottom second dual roller assembly 1540, the use of the one or more wobbly roller assembly 600, and/or the use of the one or more deflectors 650 described herein provide for improved application of the activated WAT tape 200 to the carton 100. At higher speeds, the WAT tape 200 may be applied to the carton 100 before it becomes sticky enough (e.g., before the water sufficiently activates the adhesive layer of the WAT tape 200) to adhere to the carton 100 (e.g., the fibers of the carton 100). As such, these assemblies and/or components thereof restrict (e.g., prevent, reduce, or the like) the WAT tape legs from popping off the carton, the WAT tape from being applied misaligned (e.g., shifting after application), the WAT tape 200 from having bubbles and/or creases (e.g., during initial application), or the like that may result in improper carton sealing. Moreover, in some embodiments the wobbly roller assembly 600 may only be used on one or more of the rollers of the top second dual roller assembly 540 and/or the bottom second dual roller assembly 1540. In some embodiments, using the wobbly roller assembly 600 on the rollers of the top first dual roller assembly 510 and/or the bottom first dual roller assembly 1510 may cause the WAT tape 200 to slide off center because the WAT tape 200 is not sticky enough to properly stick to the carton 100 and the wobbly roller that is contacting a carton surface that is out of plane may slide the tape to one side or the other. However, when the wobbly rollers are used on the top second dual roller assembly 540 and/or the bottom second dual roller assembly 1540, the WAT tape 200 is sticky enough such that the wobbly roller would not slide the WAT tape 200 when the carton surface is out of the plane. As such, the use of the one or more assemblies and/or one or more components thereof, allow the carton 100 to be sealed at higher speeds. These improvements in the carton sealing apparatus 1 are particularly beneficial when thicker tapes and/or tapes with reinforcements are being used because these types of tapes are more likely to pop off a carton 100 and/or not be applied properly at higher speeds (e.g., due to the additional stiffness and less flexibility in these types of tapes).

Additionally, the top feeder assembly 400 of the top carton sealing apparatus 300 having the one or more flexible drive members 416 (e.g., a belt, chain, or the like) that are configured for a serpentine path allows for positioning the top WAT tape head assembly 700 closer to the carton in order to provide the correct tape length to the carton 100. Without the use of the serpentine flexible drive members 416 (e.g., belt, chain, or the like) the WAT tape head assembly 700 would have to be located above the flexible drive members 416, which would not allow smaller size cartons 100 to be sealed within the carton sealing apparatus 1. That is, the farther away the WAT tape head assembly 700 is located from the carton 100 the longer the tape legs for the leading and trailing sides 105, 106 of the carton 100, and as such, the tape legs cannot be applied to cartons having shorter heights (e.g., the ends of the tape would overhang the shorter leading and trailing sides of the carton 100).

Additionally, the use of the top tape feeder assembly 710 that uses the top pinch roller assembly 730 (e.g., a top driven roller 732, a top pinch roller 734), the bottom tape feeder assembly 1710 that uses the bottom pinch roller assembly 1730 (e.g., a bottom driven roller 732, a bottom pinch roller 734), and the controller 2010 that operates these assemblies can be used to drive the tape (e.g., top and bottom tape) for application on the carton 100 at a tape speed that corresponds (e.g., that is the same or similar) to the carton speed at which the carton 100 is being feed through the carton sealing apparatus 1 (e.g., based on one or more sensors, such as an encoder attached to one or more of the carton feeder assemblies 400, 1400). In traditional systems, the WAT tape 200 is initially selectively fed through the WAT tape head assembly until it is stuck to the carton 100 (e.g., at a speed that is not aligned with the carton speed) and the movement of the carton 100 through the carton sealing apparatus 1 pulls the WAT tape 200 from the tape supplies. However, at higher speeds, and in particular, when the WAT tape 200 is not tacky enough to adhere to the carton 100, the carton 100 cannot properly pull the WAT tape 200, which results in the WAT tape 200 being improperly applied to the carton 200 (e.g., slipping, bunching, peeling-off, or the like from the carton 200). As such, actively driving the speed at which the WAT tape 200 is fed through the WAT tape head assemblies 700, 1700 at a speed that corresponds to the speed at which the carton 100 is being feed through the carton sealing apparatus 1 reduces the tension on the WAT tape 200 that is being pulled by the carton 100 (e.g., from the last attached point on the carton 100 to the location of the pinch roller assemblies 730, 1730), and thus, restricts (e.g., eliminates, reduces, or the like) the improper application (e.g., slippage, misalignment, bunching or the like) of the WAT tape 200. It should be further understood that the speed at which the WAT tape 200 is fed may change based on the speed at which different sized cartons 100 are being fed through the carton sealing apparatus 1 because different sized cartons 100 may be fed at different speeds. Consequently, by feeding the WAT tape 200 as it is being applied to the carton 100, the carton sealing apparatus 1 may operate at higher speeds and still effectively seal the cartons 100.

It should be further understood that the water supply assembly 1000 described herein provides for more uniform application of water to the adhesive layer of the WAT tape 100. That is, maintaining the level of water in the water pots 770, 1770, through the use of the reservoirs 1022, 1052 and/or one or more pumps 1040, 1070 (e.g., in particular one or more peristaltic pumps) maintains the level of water at the desired levels for more uniform application of water to the WAT tape 200 (e.g., to both the top WAT tape and bottom WAT tape). Applying too much water to the WAT tape 200 may dilute the tackiness of the WAT adhesive, and thus results in WAT tape that is not properly adhered to the carton (e.g., slips, bunches, and/or peels-off of the carton 100). Alternatively, not applying enough water to the WAT tape 200 may not properly activate the adhesive over the entire surface of the WAT tape 200, and thus may fail to activate the tackiness of the WAT tape 200 fast enough for it to adhere properly to the carton 100. As such, the uniform and repeatable application of the desired amount of water optimizes the tackiness of the WAT tape 200, and thus, improves the speed at which the WAT tape 200 may be applied to the carton 100.

It should be understood that “operatively coupled,” “coupled,” “connected,” and/or other like terms when used herein, means that the components may be formed integrally with each other, or may be formed separately and coupled together. Furthermore, “operatively coupled,” “coupled,” “connected,” and/or other like terms means that the components may be formed directly to each other, or to each other with one or more components located between the components that are “operatively coupled,” “coupled,” “connected,” and/or other like term together. Furthermore, “operatively coupled,” “coupled,” “connected,” and/or other like term may mean that the components are detachable from each other, or that they are permanently coupled together.

Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa. In addition, where possible, any terms expressed in the singular form herein are meant to also include the plural form and/or vice versa, unless explicitly stated otherwise. Accordingly, the terms “a”and/or “an”shall mean “one or more.

Certain terminology is used herein for convenience only and is not to be taken as limiting, unless such terminology is specifically described herein for specific embodiments. For example, words such as “top”, “bottom”, “upper”, “lower”, “first”, “second”, “inner”, “outer”, or the like may merely describe the configurations shown in the Figures and described herein for some embodiments of the disclosure. Indeed, the components may be oriented in any direction and the terminology, therefore, should be understood as encompassing such variations unless specified otherwise. The terminology includes the words specifically mentioned above, derivatives thereof and words of similar import.

While certain exemplary embodiments have been described and shown in the accompanying drawings, it is to be understood that such embodiments are merely illustrative of and not restrictive on the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the disclosure. Therefore, it is to be understood that, within the scope of the appended claims, the disclosure may be practiced other than as specifically described herein.

What is claimed is:

1. A carton sealing apparatus utilizing water activated tape (WAT) to seal a carton, the apparatus comprising:
a top carton sealing assembly comprising:
a top carton feeder assembly;
a top WAT tape head assembly; and
a top applicator assembly; and
a bottom carton sealing assembly comprising:
a bottom carton feeder assembly;
a bottom WAT tape head assembly; and
a bottom applicator assembly;
wherein the carton is configured to be at least partially fed through the apparatus by the top carton sealing assembly contacting an upper surface of the carton and the bottom carton feeder assembly contacting a lower surface of the carton.

2. The carton sealing apparatus of claim 1, wherein the top carton feeder assembly comprises:
a drive assembly comprising:
a drive roller;
a motor; and
two or more guide rollers; and
a belt operatively coupled to the drive roller and the two or more guide rollers;
wherein the drive roller and at least one of the two or more guide rollers are offset vertically to provide a serpentine path for the belt; and
wherein the belt is configured to contact the upper surface of the carton to feed the carton through the apparatus.

3. The carton sealing apparatus of claim 1, wherein the top applicator assembly comprises:
a top roller assembly comprising:
a top first dual roller assembly comprising:
a top first leading tape leg roller; and
a top first trailing tape leg roller;
a top second dual roller assembly comprising:
a top second leading tape leg roller; and
a top second trailing tape leg roller.

4. The carton sealing apparatus of claim 3, wherein the bottom applicator assembly comprises:
a bottom roller assembly comprising:
a bottom first dual roller assembly comprising:
a bottom first leading tape leg roller; and
a bottom first trailing tape leg roller;
a bottom second dual roller assembly comprising:
a bottom second leading tape leg roller; and
a bottom second trailing tape leg roller.

5. The carton sealing apparatus of claim 4, wherein one or more of the top second leading tape leg roller, the top second trailing tape leg roller, the bottom second leading tape leg roller, or the bottom second trailing tape leg roller comprises a wobbly roller assembly, wherein the wobbly roller assembly comprises:
an axle;
a pivot connector operatively coupled to the axle; and
a roller with an axle aperture therethrough extending over the axle and the pivot connector;
wherein the roller is configured to rotate around the axle and pivot with respect to an axle axis of the axle around the pivot connector.

6. The carton sealing apparatus of claim 4, wherein at least one of the top second dual roller assembly or the bottom second dual roller assembly comprises:
a deflector;
wherein the deflector is configured to guide a top leading tape leg or a bottom leading tape leg over the top second leading tape leg roller or the bottom second leading tape leg roller when the top leading tape leg or the bottom leading tape leg pop off of a leading side of the carton after application by the top first leading tape leg roller or the bottom first leading tape leg roller.

7. The carton sealing apparatus of claim 1, wherein the top WAT tape head assembly or the bottom WAT tape head assembly comprise:
a tape feeder assembly comprising:
a tape motor;
a driven tape roller operatively coupled to the tape motor; and
a pinch roller;
wherein the driven tape roller and the pinch roller are configured to feed the tape at a speed that corresponds to a belt speed.

8. The carton sealing apparatus of claim 1, further comprising:
a bottom tape supply assembly comprising:
a tape roll mandrel for supporting a tape roll;
one or more guide rollers; and
one or more turn members.

9. The carton sealing apparatus of claim 8, wherein the tape roll mandrel is operatively coupled to a side of the carton sealing apparatus, wherein the tape roll is operatively coupled to the tape roll mandrel is offset from a centerline of the carton sealing apparatus, and wherein the one or more turn members comprise:
a first turn member to turn tape from the tape roll towards the centerline of the carton sealing apparatus; and
a second turn member to turn the tape at the centerline of the carton sealing apparatus to the bottom WAT tape head assembly.

10. The carton sealing apparatus of claim 8, wherein the bottom tape supply assembly further comprises:
a tape roll storage assembly located under the carton sealing apparatus;
wherein the one or more turn members comprise a first member configured to turn the tape at a centerline of the carton sealing apparatus to the bottom WAT tape head assembly; and
wherein the tape roll storage assembly is configured to be retracted for storage under the carton sealing apparatus during operation and extended adjacent the carton sealing apparatus for supplying a new tape roll.

11. The carton sealing apparatus of claim 10, wherein the tape roll storage assembly comprises:
one or more tape roll tracks;
one or more tape roll carriages operatively coupled to the one or more tape roll tracks;
wherein the mandrel is located on the one or more tape roll carriages.

12. The carton sealing apparatus of claim 1, further comprising:
a water supply assembly comprising:
one or more water supplies;
a top water supply assembly comprising:
a top water reservoir;
a top reservoir input operatively coupling the top water reservoir with the one or more water supplies;
a top reservoir output operatively coupling the top water reservoir with the one or more water supplies; and
a top water pot conduit operatively coupling the top water reservoir with a top water pot in the top WAT tap head assembly;
a bottom water supply assembly comprising:
a bottom water reservoir;
a bottom reservoir input operatively coupling the bottom water reservoir with the one or more water supplies;
a bottom reservoir output operatively coupling the bottom water reservoir with the one or more water supplies; and
a bottom water pot conduit operatively coupling the bottom water reservoir with a bottom water pot in the top WAT tap head assembly; and
one or more pumps operatively coupled to the top reservoir input, the top reservoir output, the bottom reservoir input, and the bottom reservoir output, wherein the one or more pumps circulate water between the top water reservoir and the one or more water supplies and the bottom water reservoir and the one or more water supplies.

13. The carton sealing apparatus of claim 12, wherein the one or more water supplies comprise a water tank with a water volume for a top supply roll or a bottom supply roll.

14. The carton sealing apparatus of claim 12, wherein the one or more pumps comprise one or more peristaltic pumps.

15. The carton sealing apparatus of claim 1, further comprising:
a gate assembly comprising:
a gate member;
a gate drive operatively coupled to the gate member;
wherein the gate drive is configured to rotate the gate member into a retracted position when the carton sealing apparatus is ready for sealing the carton; and
wherein the gate drive is configured to rotate the gate member into an extended position when the carton sealing apparatus is not ready for sealing the carton.

16. The carton sealing apparatus of claim 1, further comprising:
one or more sensors; and
a controller, wherein the controller comprises:
one or more memory components with computer-readable program code stored thereon; and
one or more processing devices operatively coupled to the one or more memory devices, wherein when executed the computer-readable program code is configured to cause the one or more processing components to:
identify the carton for sealing; and
operate the carton sealing apparatus for sealing top flaps and bottom flaps of the carton.

17. The carton sealing apparatus of claim 16, wherein when executed the computer-readable program code is further configured to cause the one or more processing components to:
identify when the carton is ready for sealing;
determine a previous carton is still being sealed; and
move the top carton sealing assembly upward to restrict the top carton feeder assembly from engaging the carton to restrict damage to the carton before sealing.

18. The carton sealing apparatus of claim 16, wherein when executed the computer-readable program code is further configured to cause the one or more processing components to:
receive a request to pass a sealed carton through the carton sealing apparatus; and
move the top carton sealing assembly upwards to allow one or more cartons to pass through the carton sealing apparatus without sealing the one or more cartons with the tape.

19. The carton sealing apparatus of claim 1, wherein the carton sealing apparatus seals cartons at speeds of over 100 ft/min.
